(19) United States
(12) Patent Application Publication
(10) Pub. No.: US 2014/0112367 A1
(43) Pub. Date: Apr. 24, 2014

(54) CALIBRATION OF A HAND-HELD MEDICAL DEVICE BY A MOBILE DEVICE

(71) Applicant: BROOKLANDS, INC., Boca Raton, FL (US)

(72) Inventor: Jason Roth, Boca Raton, FL (US)

(73) Assignee: BROOKLANDS, INC., Boca Raton, FL (US)

(21) Appl. No.: 13/656,621

(22) Filed: Oct. 19, 2012

(51) Int. Cl. G01K 15/00

(52) U.S. Cl. CPC G01K 15/005
USPC 374/1

(57) ABSTRACT

Systems, methods and apparatus are provided through which in some implementations a non-contact thermometer is diagnosed and calibrated under instruction of a mobile phone.

### FIELD

This disclosure relates generally to digital thermometers, and more particularly to calibration of a hand-held medical device by a mobile device.

### BACKGROUND

Conventional non-contact digital thermometers are calibrated by a rather large and complex electronic device.

### BRIEF DESCRIPTION

In one aspect, a method of a hand-held medical device includes connecting to a mobile device via a cable, recognizing the mobile device, entering a calibration and diagnostic mode, sending configuration data to the mobile device, receiving generated diagnostic instructions for the hand-held medical device from the mobile device, performing the generated diagnostic instructions, yielding results of performed diagnostic mobile service, receiving generated calibration instructions for the hand-held medical device from the mobile device, performing the generated calibration instructions, yielding results of performed calibration instructions, and transmitting the results of the performed calibration instructions to the mobile device.

In another aspect, a method of a hand-held medical device includes sending configuration data to a mobile device, receiving diagnostic instructions for the non-contact thermometer from the mobile device, transmitting results of the diagnostic instructions to the mobile device, receiving calibration instructions for the hand-held medical device from the mobile device; and transmitting the results of the calibration instructions to the mobile device.

In yet another aspect, a non-transitory computer-accessible medium having computer executable instructions to control a hand-held medical device, the computer executable instructions capable of directing a processor to receive calibration instructions for the hand-held medical device from a mobile device and transmit results of the calibration instructions to the mobile device.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to manage diagnostics and calibration of a hand-held medical device by a mobile device, according to an implementation;

FIG. 2 is a block diagram of an overview of a system to manage diagnostics and calibration of a non-contact and contact thermometer by a mobile device, according to an implementation;

FIG. 3 is a block diagram of apparatus to measure temperature from multiple source points, according to an implementation;

FIG. 4 is a block diagram of apparatus to measure temperature from a carotid source point, according to an implementation;

FIG. 5 is an isometric top-view block diagram of an apparatus to measure temperature using both a hand-held medical device with a right-angled waveguide and not including a contact thermometer, according to an implementation;

FIG. 6 is a side-view block diagram of an apparatus to measure temperature using a hand-held medical device with a right-angled waveguide, according to an implementation;

FIG. 7 is an isometric block diagram of an apparatus to measure temperature using both hand-held medical device with a right-angled waveguide and contact thermometer, according to an implementation;

FIG. 8 is a block diagram of apparatus to measure temperature, according to an implementation having a right-angled waveguide;

FIG. 9 is a block diagram of apparatus to measure temperature, according to an implementation in which each of a hand-held medical device and a contact thermometer are controlled by a separate printed circuit board and the hand-held medical device has a right-angled waveguide, according to an implementation;

FIG. 10-15 are block diagrams of a sensor collector to guide electromagnetic energy to measure temperature, according to an implementation;

FIG. 16-21 are block diagrams of a shroud of a sensor collector to guide electromagnetic energy to measure temperature, according to an implementation;

FIG. 22 is a representation of display that is presented on the display device of apparatus in FIG. 3-7, according to an implementation that manages both a non-contact sensor and a contact sensor;

FIG. 23 is a representation of display that is presented on the display device of apparatus in FIG. 3-7, according to an implementation;

FIG. 24 is a representation of text displays that are presented on the display device of apparatus in FIG. 3-7, according to an implementation;

FIG. 25-30 are representations of graphical displays that are presented on the display device of apparatus in FIG. 3-7, according to implementations;

FIG. 31-32 is a series of sequence diagrams of the interaction between a mobile device and a hand-held medical device, according to an implementation;

FIG. 33 is a flowchart of a method of calibrating a hand-held medical device that is in communication with a mobile device, the method performed by the hand-held medical device, according to an implementation;

FIG. 34 is a flowchart of a method of calibrating a hand-held medical device that is in communication with a mobile device, the method is performed by the mobile device, according to an implementation;

FIG. 35 is a flowchart of a method of a mobile device receiving notice of the completed calibration and the date/time of the hand-held medical device;

FIG. 36 is a flowchart of a method to measure temperature from multiple source points;

FIG. 37 is a flowchart of a method to measure temperature of a forehead and a carotid artery, according to an implementation;

FIG. 38 is a flowchart of a method of determining correlated temperature of carotid artery, according to an implementation;

FIG. 39 is a flowchart of a method of forehead and carotid artery sensing, according to an implementation;

FIG. 40 is a flowchart of a method to display temperature color indicators, according to an implementation;

FIG. 41 is a flowchart of a method to display temperature color indicators, according to an implementation of three colors;

FIG. 42 is a block diagram of a mobile device, according to an implementation;

FIG. 43, a block diagram of the communication subsystem component is shown, according to an implementation;

FIG. 44 is a block diagram of a thermometer control computer, according to an implementation; and

FIG. 45 is a block diagram of a data acquisition circuit of a thermometer control computer, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into four sections. In the first section, an overview of implementations is described. In the second section, apparatus of implementations are described. In the third section, implementations of methods are described. In the fourth section, a hardware and the operating environment in conjunction with which implementations may be practiced are described. Finally, in the fifth section, a conclusion of the detailed description is provided.

### Overview

A system level overview of the operation of an implementation is described in this section of the detailed description.

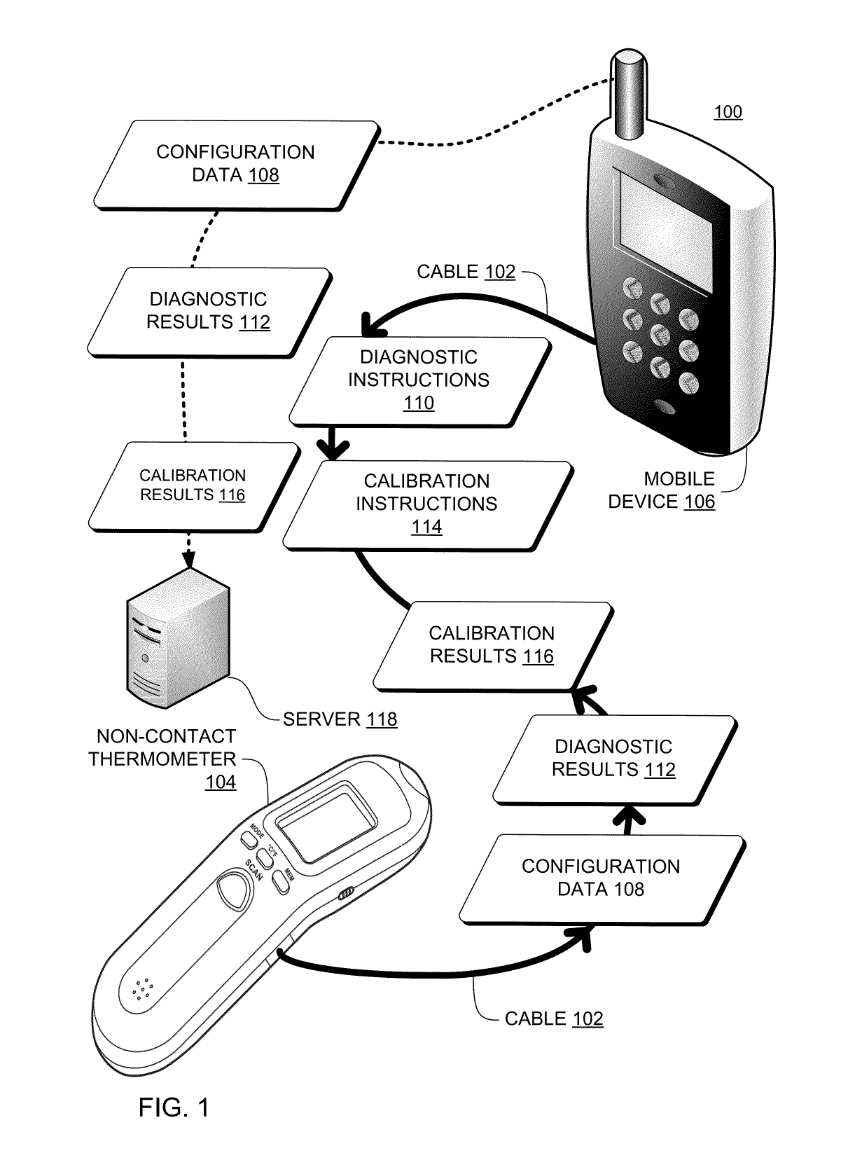

FIG. 1 is a block diagram of an overview of a system 100 to manage diagnostics and calibration of a hand-held medical device by a mobile device, according to an implementation. System 100 provides a convenient means to perform diagnostics and calibration of a hand-held medical device.

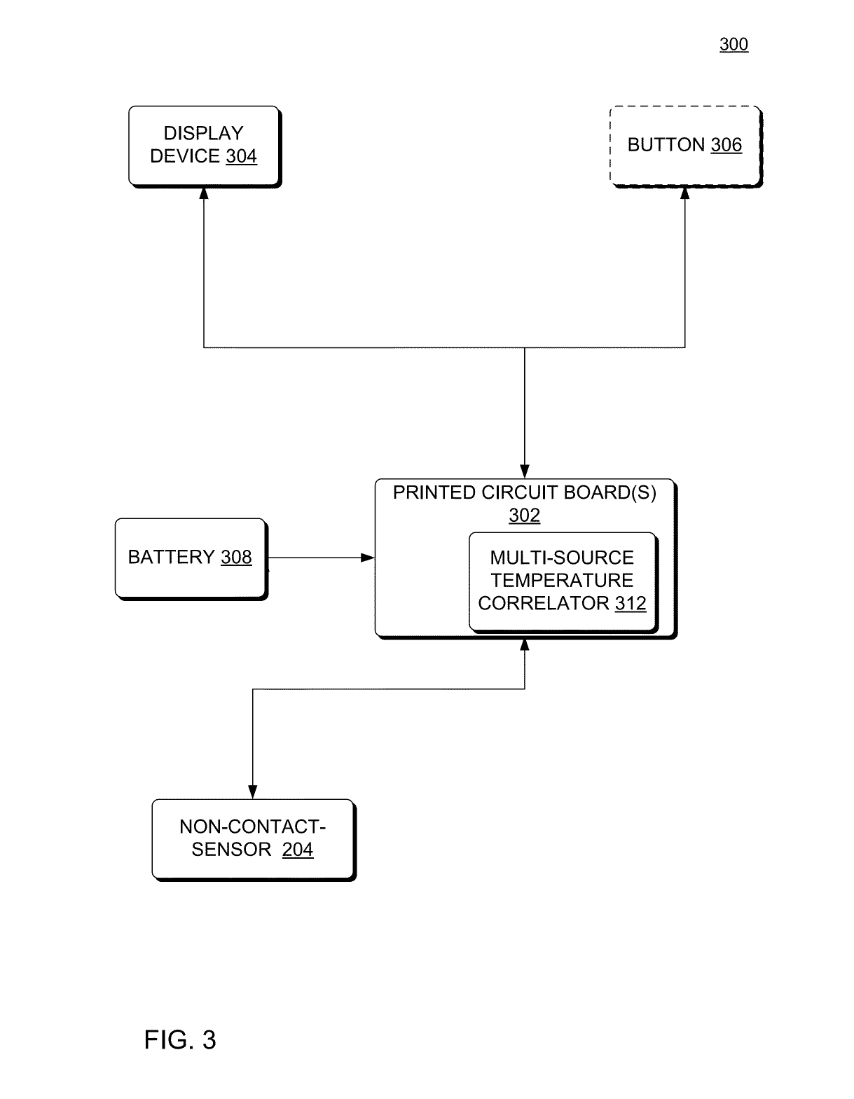

After a hand-held medical device 104 is connected to a mobile device 106 through a cable 102 or a wireless connection, configuration data 108 is transmitted from the hand-held medical device 104 through the cable 102 and to the mobile device 106. Examples of the hand-held medical device 104 are the non-contact thermometers as described in FIG. 3-8. The configuration data 108 describes and represents the hardware characteristics and functional capabilities of the hand-held medical device 104. The mobile device 106 generates diagnostic instructions 110 from the configuration data 108 and transmits the diagnostic instructions 110 through the cable 102 to the hand-held medical device 104. The hand-held medical device 104 performs or executes the diagnostic instructions 110 from which diagnostic results 112 are generated and transmitted through the cable 102 to the mobile device 106.

The mobile device 106 generates calibration instructions 114 from the configuration data 108 and transmits the calibration instructions 114 through the cable 102 to the hand-held medical device 104. The hand-held medical device 104 performs or executes the calibration instructions 114 from which calibration results 116 are generated and transmitted through the cable 102 to the mobile device 106. In some implementations, the mobile device 106 generates a notice of the completed calibration in reference to the date/time and the calibration results 116 and transmits the notice of the completed calibration to a server 118 of a compliance office. In some implementations, the mobile device 106 transmits the configuration data 108, the diagnostic results 112 and/or the calibration results 116 to the server 118 of the compliance office.

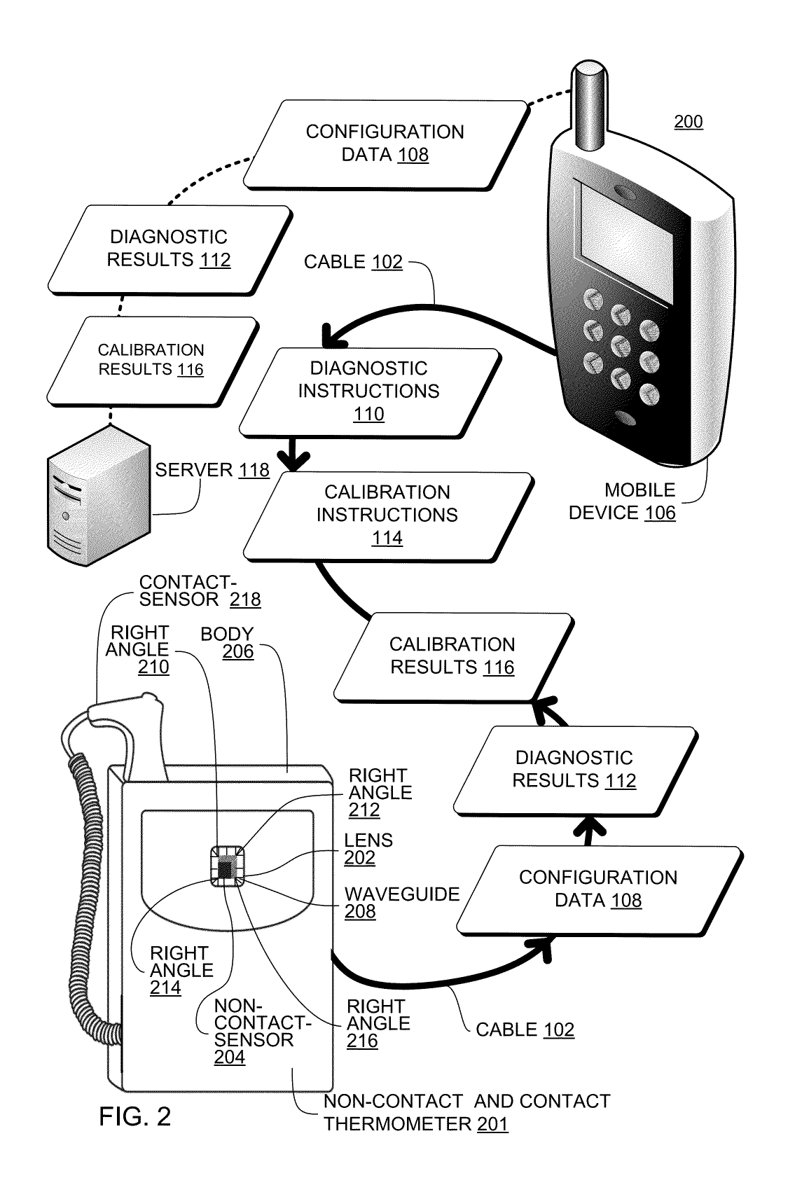

FIG. 2 is a block diagram of an overview of a system 200 to manage diagnostics and calibration of a non-contact and contact thermometer by a mobile device, according to an implementation. System 200 provides a convenient means to perform diagnostics and calibration of a non-contact and contact thermometer 201. The non-contact and contact thermometer 201 is handheld and battery powered for intermittent measurement and monitoring of human or animal body temperature of people of all ages. The non-contact and contact thermometer 201 measures both infrared energy emitted from the skin surface of the human or animal and direct body temperature.

The non-contact and contact thermometer 201 includes a lens 202 of the non-contact sensor 204, the lens 202 being mounted on the exterior of the body 206 of the Non-contact and contact thermometer 201. The non-contact sensor 204 behind the lens 202 detects temperature in response to remote sensing of a surface a human or animal. A right-angled waveguide 208 is positioned in proximity to the non-contact sensor 204. The right-angled waveguide 208 includes at least one flat planar surface and right angles 210, 212, 214 and 216 The non-contact and contact thermometer 201 also includes the contact sensor 218 that is mounted on the exterior of the body 206 of the non-contact and contact thermometer 201. The contact sensor 218 detects temperature in response to direct contact with the human or animal. The dual sensors 204 and 218 provide both convenience and heightened accuracy in detecting temperatures in humans or animals. In some situations, the non-contact sensor 204 is used as an initial instrument of temperature detection of a human or animal and the contact sensor 218 is used as a second instrument of temperature detection of the human or animal.

After the non-contact and contact thermometer 201 is connected to a mobile device 106 through the cable 102, configuration data 108 is transmitted from the non-contact and contact thermometer 201 through the cable 102 and to the mobile device 106. The configuration data 108 describes and represents the hardware characteristics and functional capabilities of non-contact and contact thermometer 201. The mobile device 106 generates diagnostic instructions 110 from the configuration data 108 and transmits the diagnostic instructions 110 through the cable 102 to the non-contact and contact thermometer 201. The non-contact and contact thermometer 201 performs or executes the diagnostic instructions 110 from which diagnostic results 112 are generated and transmitted through the cable 102 to the mobile device 106.

The mobile device 106 generates calibration instructions 114 from the configuration data 108 and transmits the calibration instructions 114 through the cable 102 to the non-contact and contact thermometer 201. The non-contact and contact thermometer 201 performs or executes the calibration instructions 114 from which calibration results 116 are generated and transmitted through the cable 102 to the mobile device 106. In some implementations, the mobile device 106 generates a notice of the completed calibration in reference to the date/time and the calibration results 116 and transmits the notice of the completed calibration to the server 118 of the compliance office. In some implementations, the mobile device 106 transmits the configuration data 108, the diagnostic results 112 and/or the calibration results 116 to the server 118 of the compliance office.

### Apparatus Implementations

In this section, particular apparatus of implementations are described by reference to a series of diagrams.

FIG. 3 is a block diagram of apparatus 300 to measure temperature from multiple source points, according to an implementation. A source point is an external point or position. Apparatus 300 is handheld and battery powered for intermittent measurement and monitoring of human or animal body temperature of people of all ages. Apparatus 300 measures electromagnetic energy emitted from multiple source points of the skin surface, such as infrared energy, of the human or animal and direct body temperature. Apparatus 300 is operationally simple enough to be used by consumers in the household environment, yet accurate enough to be used by professional medical facilities.

Apparatus 300 includes one or more printed circuit board(s) 302.

Apparatus 300 also includes a display device 304 that is operably coupled to the one or more printed circuit board(s) 302. Some implementations of apparatus 300 also include a button 306 that is operably coupled to the one or more printed circuit board(s) 302. Apparatus 300 also includes a battery 308, such as a lithium ion battery, that is operably coupled to the one or more printed circuit board(s) 302.

Apparatus 300 also includes a non-contact sensor 204 that is operably coupled to the one or more printed circuit board(s) 302. The non-contact sensor 204 detects temperature in response to remote sensing of a surface a human or animal. In some implementations, the hand-held medical device is an infrared temperature sensor. All humans or animals radiate infrared energy. The intensity of this infrared energy depends on the temperature of the human or animal, thus the amount of infrared energy emitted by a human or animal can be interpreted as a proxy or indication of the temperature of the human or animal. The non-contact sensor 204 measures the temperature of a human or animal based on the electromagnetic energy radiated by the human or animal. The measurement of electromagnetic energy is taken by the non-contact sensor 204 which constantly analyzes and registers the ambient temperature. When the operator of apparatus 300 holds the non-contact sensor 204 about 5-8 cm (2-3 inches) from the forehead and activates the radiation sensor, the measurement is instantaneously measured. To measure a temperature using the non-contact sensor 204, pushing the button 306 causes a reading of temperature measurement from the non-contact sensor 204 and the measured temperature is thereafter displayed on the display device 304.

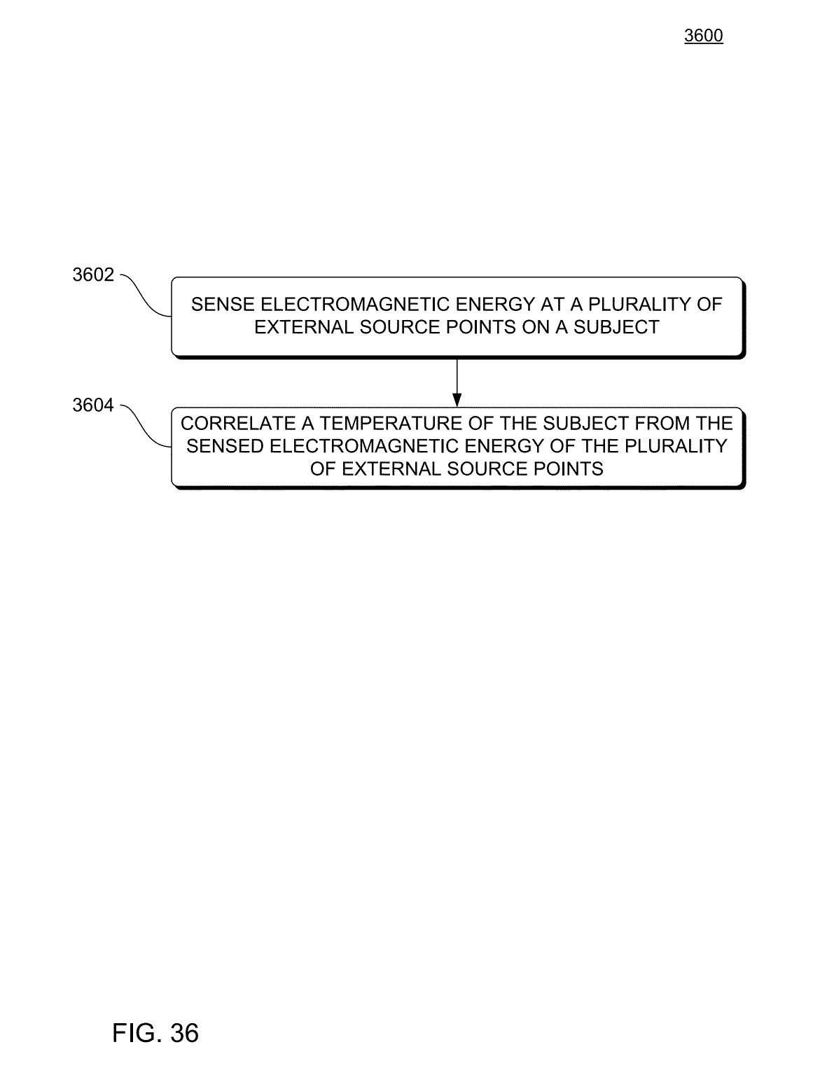

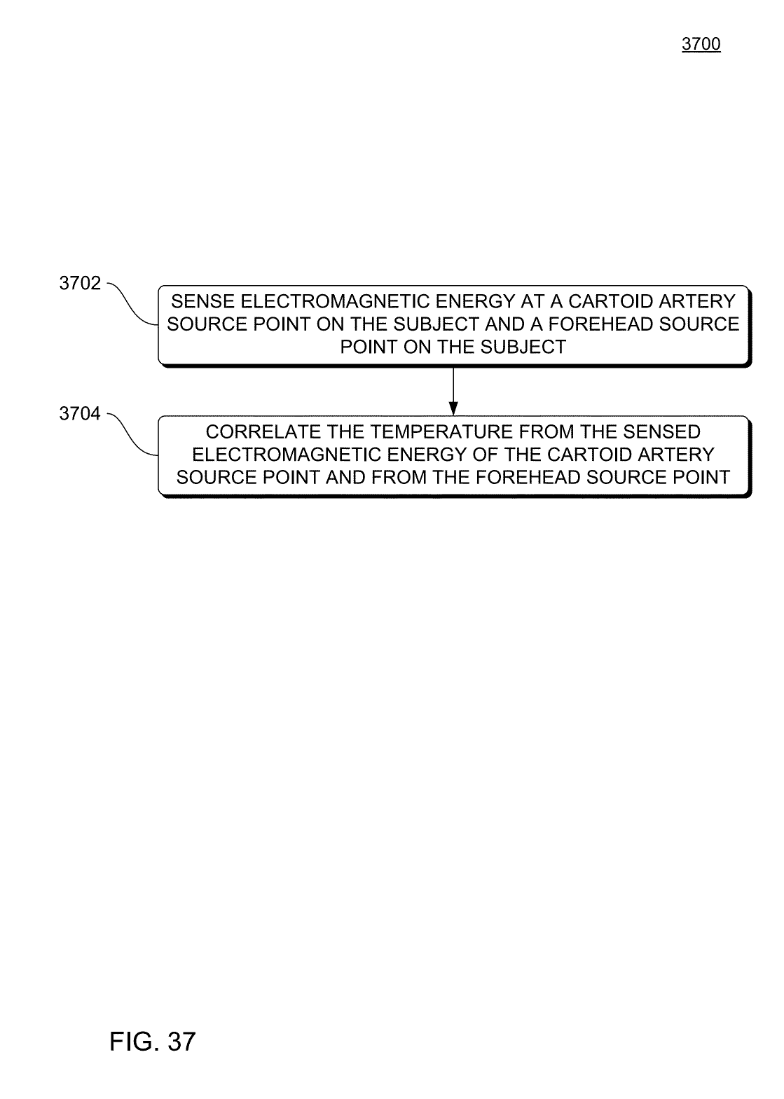

Body temperature of a human or animal can be measured in many surface locations of the body. Most commonly, temperature measurements are taken of the forehead, mouth (oral), inner ear (tympanic), armpit (axillary) or rectum. In addition, temperature measurements are taken of a carotid artery (the external carotid artery on the right side of a human neck). An ideal place to measure temperature is the forehead in addition to the carotid artery. When electromagnetic energy is sensed from two or more source points, for example, the forehead and the external carotid artery on the right side of a human neck, a multi-source temperature correlator 312 performs one or more of the correlating actions in the methods as described in FIG. 36-39. The multi-source temperature correlator 312 correlates the temperatures sensed by the non-contact sensor 204 from the multiple source points (e.g. the forehead and the carotid artery) to another temperature, such as a core temperature of the subject, an axillary temperature of the subject, a rectal temperature of the subject and/or an oral temperature of the subject. The multi-source temperature correlator 312 can be implemented as a component on a microprocessor, such as controller chip 3704 in FIG. 37 or read-only memory.

The apparatus 300 also detects the body temperature of a human or animal regardless of the room temperature because the measured temperature of the non-contact sensor 204 is adjusted in reference to the ambient temperature in the air in the vicinity of the apparatus. The human or animal must not have undertaken vigorous physical activity prior to temperature measurement in order to avoid a misleading high temperature. Also, the room temperature should be moderate, 50° F. to 120° F.

The hand-held medical device 204 provides a non-invasive and non-irritating means of measuring human or animal temperature to help ensure good health.

In some implementations, the apparatus 300 includes only one printed circuit board 302, in which case the printed circuit board 302 includes not more than one printed circuit board 302. In some implementations, the apparatus 300 includes two printed circuit boards 302, such as a first printed circuit board and a second printed circuit board. In some implementations, the printed circuit board(s) 302 include a microprocessor. In some implementations, the apparatus 300 includes only one display device 304, in which case the display device 304 includes not more than one display device 304. In some implementations, the display device 304 is a liquid-crystal diode (LCD) display device. In some implementations, the display device 304 is a light-emitting diode (LED) display device. In some implementations, the apparatus 300 includes only one battery 308, which case the battery 308 includes not more than one battery 308.

When evaluating results, the potential for daily variations in temperature can be considered. In children less than 6 months of age daily variation is small. In children 6 months to 2 years old the variation is about 1 degree. By age 6 variations gradually increase to 2 degrees per day. In adults there is less body temperature variation.

While the apparatus 300 is not limited to any particular printed circuit board(s) 302, display device 304, button 306, battery 308, a non-contact sensor 204 and a multi-source temperature correlator 312, for sake of clarity a simplified printed circuit board(s) 302, display device 304, button 306, battery 308, a non-contact sensor 204 and a multi-source temperature correlator 312 are described.

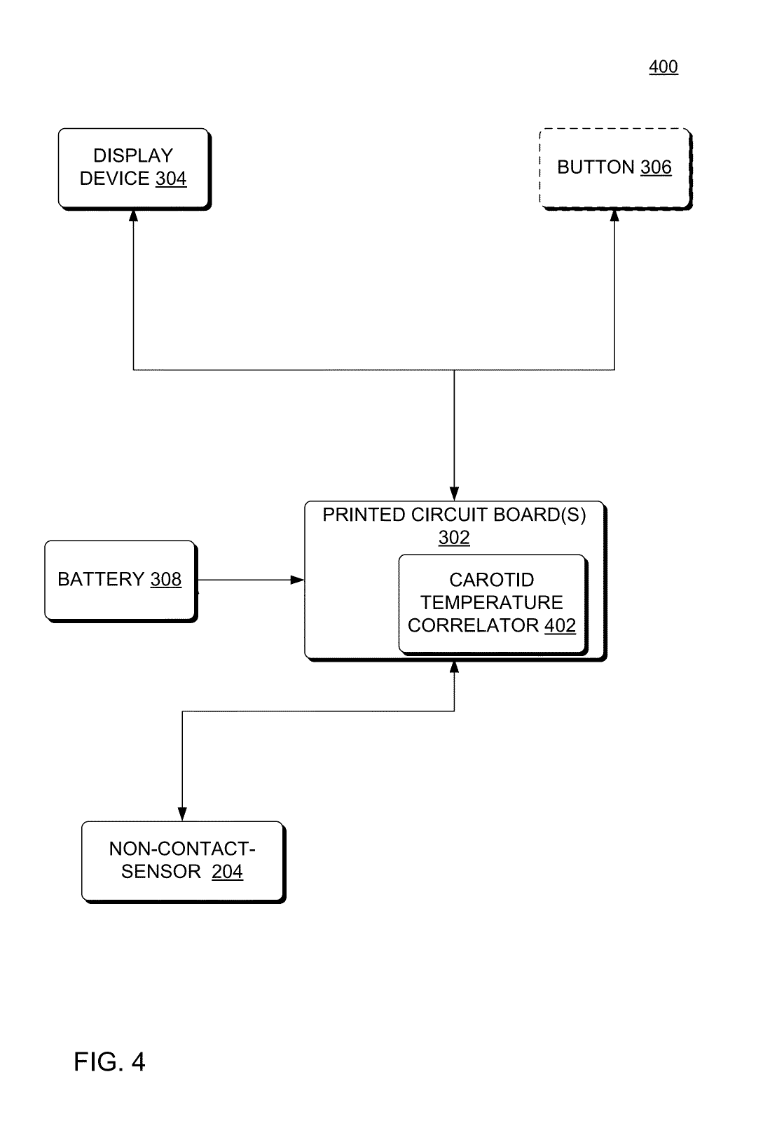

FIG. 4 is a block diagram of apparatus 400 to measure temperature from a carotid source point, according to an implementation. Apparatus 400 is handheld and battery powered for intermittent measurement and monitoring of human or animal body temperature of people of all ages. Apparatus 400 measures electromagnetic energy, such as infrared energy, emitted from a source point of the skin surface of a carotid artery of the human or animal. Apparatus 400 is operationally simple enough to be used by consumers in the household environment, yet accurate enough to be used by professional medical facilities.

Apparatus 400 includes one or more printed circuit board(s) 302 and a display device 304 that is operably coupled to the one or more printed circuit board(s) 302. Some implementations of apparatus 400 also include a button 306 that is operably coupled to the one or more printed circuit board(s) 302. Apparatus 400 also includes a battery 308, such as a lithium ion battery, that is operably coupled to the one or more printed circuit board(s) 302.

Apparatus 400 also includes a non-contact-sensor 204 that is operably coupled to the one or more printed circuit board(s) 302. The non-contact-sensor 204 detects temperature in response to remote sensing of a surface a human or animal. When the operator of apparatus 400 holds the non-contact-sensor 204 about 5-8 cm (2-3 inches) from the carotid artery and activates the non-contact-sensor 204, the measurement is instantaneously measured.

When electromagnetic energy is sensed by the non-contact-sensor 204 from the carotid artery on the right side of a human neck, a carotid temperature correlator 402 performs one or more of the correlating actions in the methods as described in FIG. 36-38. The carotid temperature correlator 402 correlates the temperatures sensed by the non-contact-sensor 204 from the carotid source point to another temperature, such as a core temperature of the subject, an axillary temperature of the subject, a rectal temperature of the subject and/or an oral temperature of the subject. The carotid temperature correlator 402 can be implemented as a component on a microprocessor, such as controller chip 3704 in FIG. 37 or read-only memory.

The apparatus 400 also detects the body temperature of a human or animal regardless of the room temperature because the measured temperature of the non-contact-sensor 204 is adjusted in reference to the ambient temperature in the air in the vicinity of the apparatus 400. The human or animal must not have undertaken vigorous physical activity prior to temperature measurement in order to avoid a misleading high temperature. Also, the room temperature should be moderate, 50° F. to 120° F.

In some implementations, the apparatus 400 includes only one printed circuit board 302, in which case the printed circuit board 302 includes not more than one printed circuit board 302. In some implementations, the apparatus 400 includes two printed circuit boards 302, such as a first printed circuit board and a second printed circuit board. In some implementations, the printed circuit board(s) 302 include a microprocessor. In some implementations, the apparatus 400 includes only one display device 304, in which case the display device 304 includes not more than one display device 304. In some implementations, the display device 304 is a liquid-crystal diode (LCD) display device. In some implementations, the display device 304 is a light-emitting diode (LED) display device. In some implementations, the apparatus 400 includes only one battery 308, which case the battery 308 includes not more than one battery 308.

While the apparatus 400 is not limited to any particular printed circuit board(s) 302, display device 304, button 306, battery 308, a non-contact-sensor 204 and a carotid temperature correlator 402, for sake of clarity a simplified printed circuit board(s) 302, display device 304, button 306, battery 308, a non-contact-sensor 204 and a carotid temperature correlator 402 are described.

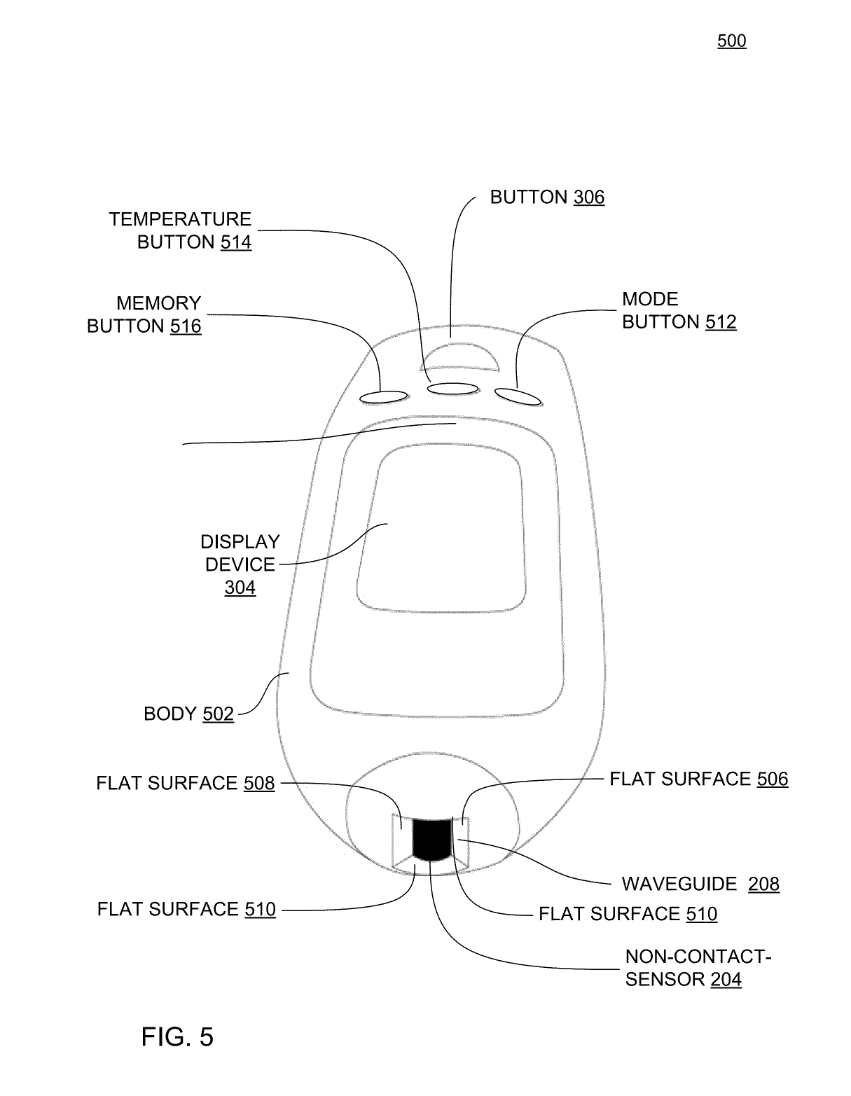

FIG. 5 is an isometric top-view block diagram of an apparatus 500 to measure temperature using both a hand-held medical device with a right-angled waveguide and not including a contact thermometer, according to an implementation. Apparatus 500 is handheld and battery powered for intermittent measurement and monitoring of human or animal body temperature of people of all ages. Apparatus 500 measures non-contact infrared energy emitted from the skin surface of the human or animal. Apparatus 500 can be used by consumers in the household environment.

Apparatus 500 includes the display device 304 that is mounted on the exterior of a body 502 or other housing of the apparatus 500. Apparatus 500 also includes the button 506 that is mounted on the exterior of the body 502 or other housing of the apparatus 500. Apparatus 500 also includes a sensor (not shown in FIG. 5) of the non-contact sensor 204 that is mounted in the interior of the body 502 of the apparatus 500. The non-contact sensor 204 detects temperature in response to remote sensing of a surface a human or animal. The right-angled waveguide 208 is positioned in proximity to the sensor 204. The right-angled waveguide 208 includes at least one flat planar surface. The apparatus 500 includes 4 flat planar surfaces 506, 508, 510 and 512.

Apparatus 500 also includes a mode button 512 that when pressed by an operator toggles or switches between three different detection modes, a first detection mode being detection and display of surface temperature, a second detection mode being detection and display of body temperature and a third detection mode being detection and display of room temperature.

Apparatus 500 also includes a temperature button 514 that when pressed by an operator toggles or switches between two different temperature modes, a first temperature mode being display of temperature in Celsius and a second temperature mode being display of temperature in Fahrenheit.

Apparatus 500 also includes a memory button 516 that when pressed by an operator toggles or switches between a plurality of past temperature readings. In one implementation, the plurality of past temperature readings is 32.

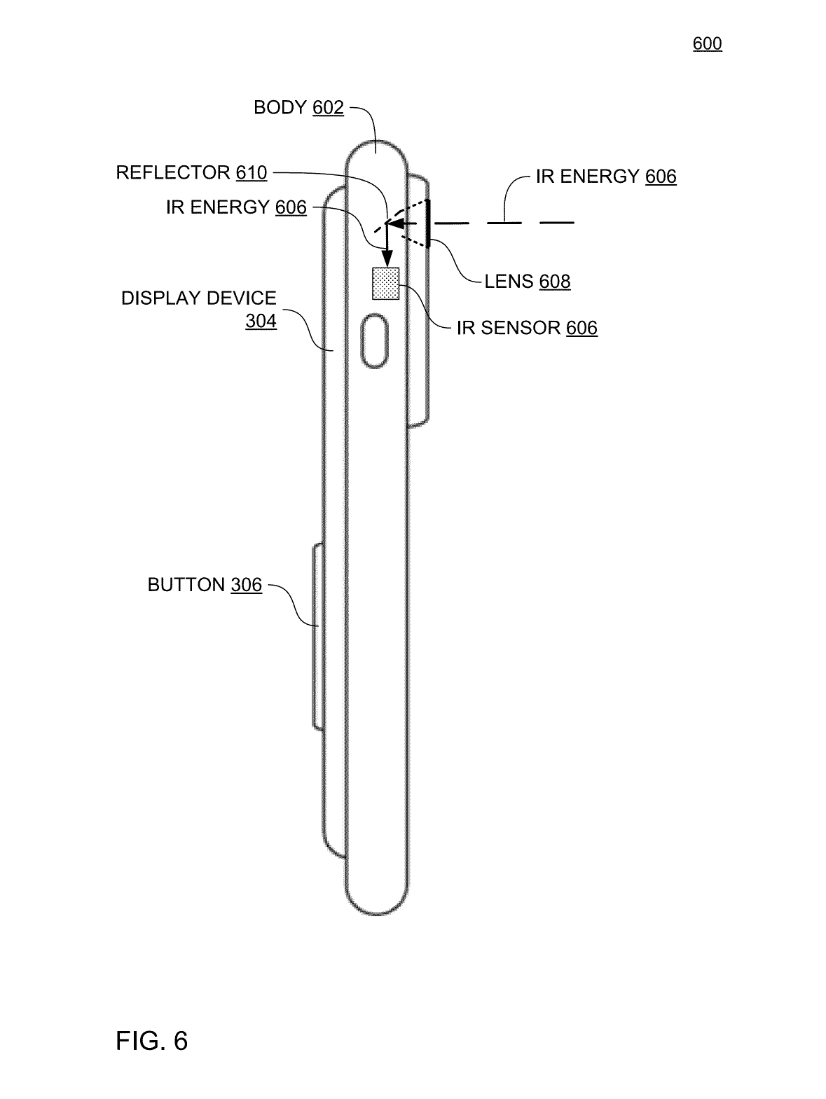

FIG. 6 is a side-view block diagram of an apparatus 600 to measure temperature using a hand-held medical device with a right-angled waveguide, according to an implementation. Apparatus 600 is handheld and battery powered for intermittent measurement and monitoring of human or animal body temperature of people of all ages. Apparatus 600 measures non-contact infrared energy emitted from the skin surface of the human or animal. Apparatus 600 can be used by consumers in the household environment.

Apparatus 600 includes the display device 304 that is mounted on the exterior of a body 602 or other housing of the apparatus 600. Apparatus 600 also includes the button 306 that is mounted on the exterior of the body 602 or other housing of the apparatus 600.

Apparatus 600 includes the non-contact sensor having an infrared sensor 604. The infrared sensor 604 is operable to receive infrared energy 606 via a pathway to the infrared sensor 604. Apparatus 600 includes a lens 608 that is positioned over the pathway. In some implementations, the lens 608 has only right-angled edges, the lens 608 being square in geometry, that is transverse to the pathway to the infrared sensor 606. The pathway intersects the lens 608. A reflector 610 that is positioned at a 45 degree angle to the infrared sensor 604. The lens 608 has a longitudinal axis that is perpendicular to a longitudinal axis of the infrared sensor. The reflector 610 is positioned at a 45 degree angle to the lens 604. The pathway is coincident to the IR energy 606 that passes through the lens 608, reflects off of the reflector 610 and to the IR sensor 604.

Apparatus 600 also includes the sensor 503 of the non-contact sensor 204, the sensor 503 being mounted in the interior of the body 502 of the apparatus 600. The non-contact sensor 204 detects temperature in response to remote sensing of a surface of a human or animal. The contact sensor 218 detects temperature in response to direct contact with the human or animal. The dual sensors 204 and 218 provide improved convenience and heightened accuracy in detecting temperatures in humans or animals. In some situations, the hand-held medical device 204 is used as initial instrument of temperature detection of a human or animal and the contact sensor 218 is used as a second instrument of temperature detection of the human or animal.

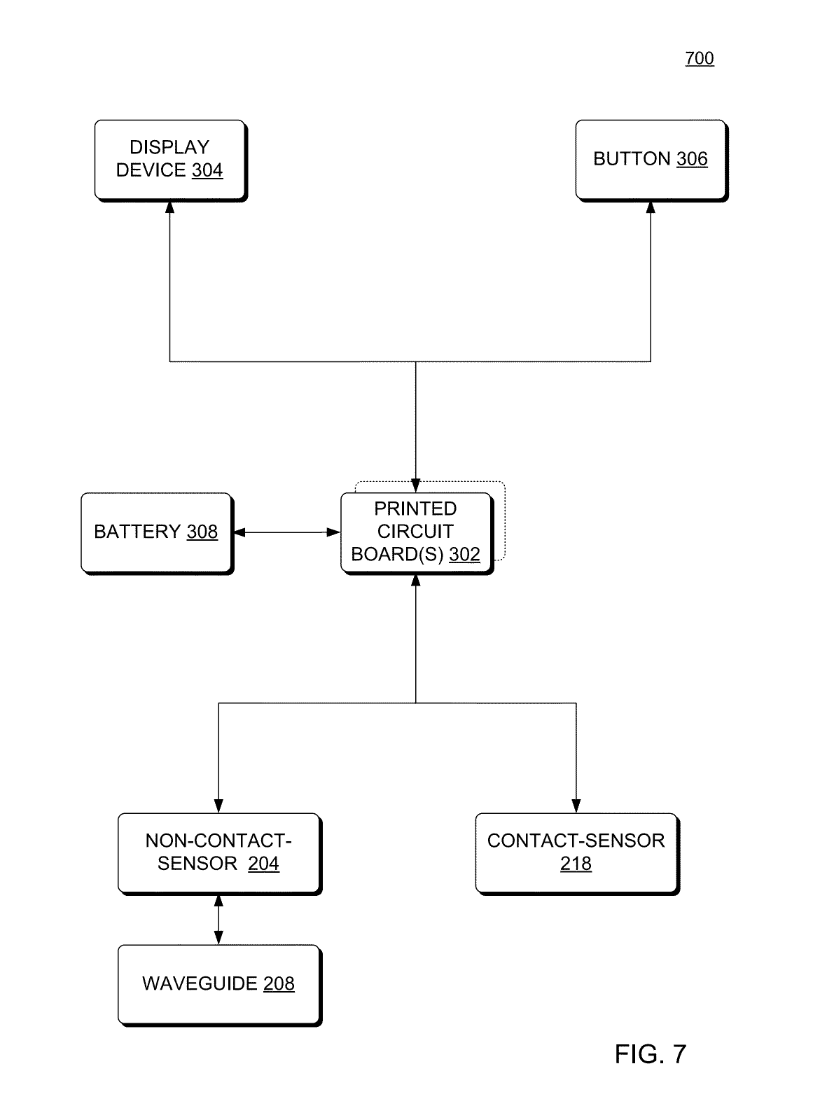

FIG. 7 is a block diagram of apparatus 700 to measure temperature, according to an implementation. Apparatus 700 is handheld and battery powered for intermittent measurement and monitoring of human or animal body temperature of people of all ages. Apparatus 700 measures both electromagnetic energy emitted from the skin surface, such as infrared energy, of the human or animal and direct body temperature. Apparatus 700 is operationally simple enough to be used by consumers in the household environment, yet accurate enough to be used by professional medical facilities.

Apparatus 700 includes one or more printed circuit board(s) 302.

Apparatus 700 also includes a display device 304 that is operably coupled to the one or more printed circuit board(s) 302. Some implementations of apparatus 700 also include a button 306 that is operably coupled to the one or more printed circuit board(s) 302. Apparatus 700 also includes a battery 308, such as a lithium ion battery, that is operably coupled to the one or more printed circuit board(s) 302.

Apparatus 700 also includes a non-contact sensor 204 that is operably coupled to the one or more printed circuit board(s) 302. The non-contact sensor 204 detects temperature in response to remote sensing of a surface a human or animal. In some implementations the hand-held medical device is an infrared temperature sensor.

Some implementations of apparatus 700 also include a contact sensor 218 that is operably coupled to the one or more printed circuit board(s) 302. The contact sensor 218 detects temperature in response to direct contact with a human or animal.

A right-angled waveguide 208 is positioned in proximity to the hand-held medical device 204. The geometry of the right-angled waveguide 208 has at least one right-angle and at least flat planar surface. In some implementations, the geometry of the right-angled waveguide 208 has only right-angled edges. In general, a waveguide is a structure of a passageway or pathway which guides waves, such as electromagnetic waves. Waves in open space propagate in all directions, as spherical waves. In this way the wave lose power proportionally to the square of the distance; that is, at a distance R from the source, the power is the source power divided by R2. The waveguide confines the wave to propagation in one dimension, so that (under ideal conditions) the wave loses no power while propagating. Waves are confined inside the waveguide due to total reflection from the waveguide wall, so that the propagation inside the waveguide can be described approximately as a “zigzag” between the walls. There are different types of waveguides for each type of wave. The original and most common implementation of a waveguide is a hollow conductive metal pipe used to carry high frequency radio waves, particularly microwaves. Waveguides differ in their geometry which can confine energy in one dimension such as in slab waveguides or a waveguide can confine energy in two dimensions as in fiber or channel waveguides. As a rule of thumb, the width of a waveguide needs to be of the same order of magnitude as the wavelength of the guided wave.

A conventional geometry of a waveguide has a circular cross-section, which is most useful for gathering electromagnetic waves that have a rotating, circular polarization in which the electrical field traces out a helical pattern as a function of time. However, infrared energy emitted from a surface of a human does not have a rotating, circular polarization in which the electrical field traces out a helical pattern as a function of time. Therefore, in apparatus that measures infrared energy of a human as a proxy of temperature of the human, circular and rounded waveguides should not be used. The waveguide 208 is not conical in geometry because a conical waveguide reflects the electromagnetic waves in a somewhat incoherent manner in which the electromagnetic waves are received at the sensor with a decreased degree of coherency, thus decreasing the signal strength; and the conical waveguide reflects a significant portion of electromagnetic waves out of the waveguide and away from the sensor, thus further reducing the signal strength of the electromagnetic waves received by the sensor and therefore further reducing the accuracy and speed of the non-contact temperature sensing. More specifically, waveguide 208 is not a conical funnel in which the conical funnel has an opening at one end of a longitudinal axis that has a larger diameter than an opening at the other end of the longitudinal axis.

The dual sensors 204 and 218 provide improved convenience and heightened accuracy in detecting temperatures in humans or animals. In some situations, the hand-held medical device 204 is used as an initial instrument of temperature detection of a human or animal and the contact sensor 218 is used as a second instrument of temperature detection of the human or animal. The non-contact sensor 204 eliminates need for contact with the skin, yet the contact sensor 218 provides a more accurate detection of human or animal body temperature to supplement or verify the temperature detected by the hand-held medical device.

In some implementations, the apparatus 700 includes only one printed circuit board 302, in which case the printed circuit board 302 includes not more than one printed circuit board 302. In some implementations, the apparatus 700 includes two printed circuit boards 302, such as a first printed circuit board and a second printed circuit board. In some implementations, the printed circuit board(s) 302 include a microprocessor. In some implementations, the apparatus 700 includes only one display device 304, in which case the display device 304 includes not more than one display device 304. In some implementations, the display device 304 is a liquid-crystal diode (LCD) display device. In some implementations, the display device 304 is a light-emitting diode (LED) display device. In some implementations, the apparatus 700 includes only one battery 308, which case the battery 308 includes not more than one battery 308.

While the apparatus 700 is not limited to any particular printed circuit board(s) 302, display device 304, button 306, battery 308, non-contact sensor 204 and a contact sensor 218, for sake of clarity a simplified printed circuit board(s) 302, display device 304, button 306, battery 308, non-contact sensor 204 and a contact sensor 218 are described.

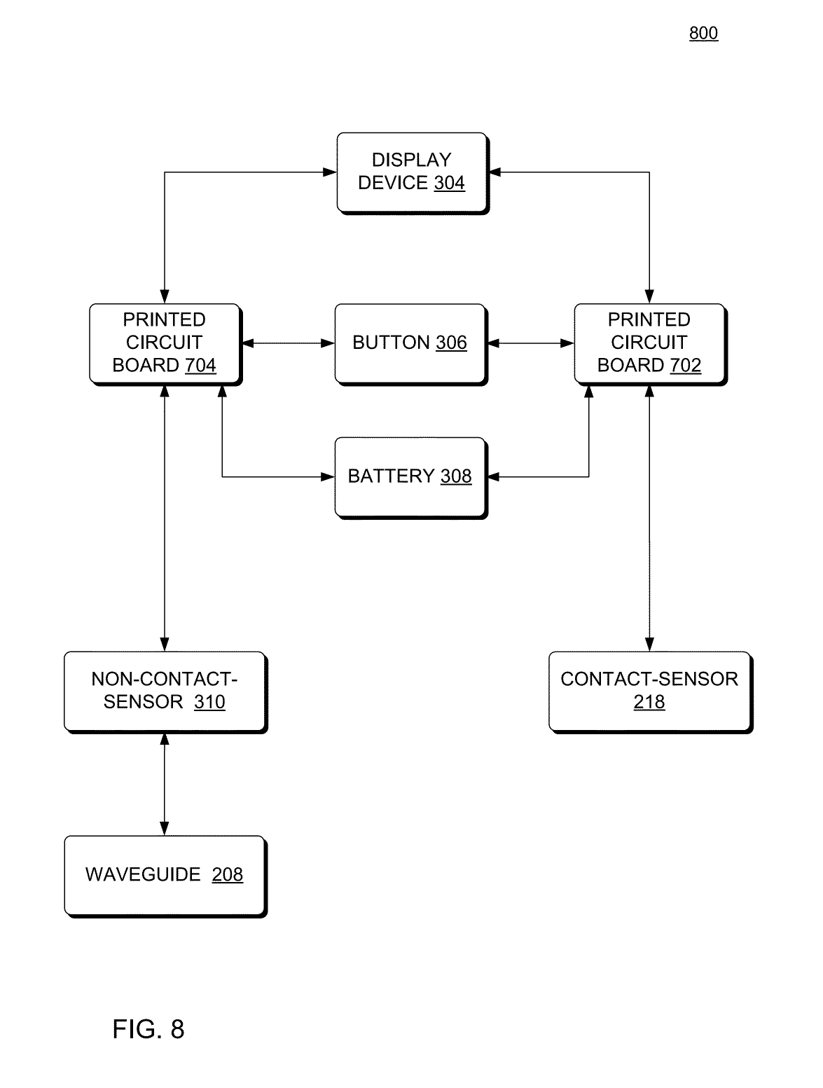

FIG. 8 is a block diagram of apparatus 800 to measure temperature, according to an implementation in which each of a hand-held medical device and a contact thermometer are controlled by a separate printed circuit board and the hand-held medical device has a right-angled waveguide, according to an implementation.

Apparatus 800 includes the contact sensor 218 that is operably coupled to a first printed circuit board 802, a non-contact sensor 204 that is operably coupled to a second printed circuit board 804, the display device 304 that is operably coupled to the first printed circuit board 802 and the second printed circuit board 804, the button 306 that is operably coupled to the first printed circuit board 802 and the second printed circuit board 804 and the battery 308 that is operably coupled to the first printed circuit board 802 and the second printed circuit board 804. In apparatus 800, the display device 304, the button 306 and the battery 308 are shared, but each thermometer has a dedicated printed circuit board.

A right-angled waveguide 208 is positioned in proximity to the hand-held medical device. The geometry of the right-angled waveguide 208 has at least one right-angle. In some implementations, the geometry of the right-angled waveguide 208 has only right-angled edges.

Some implementations of apparatus in FIG. 3-7 include an ambient air temperature sensor that is operably coupled to, or a part of, the printed circuit board(s) 302, 802 or 804.

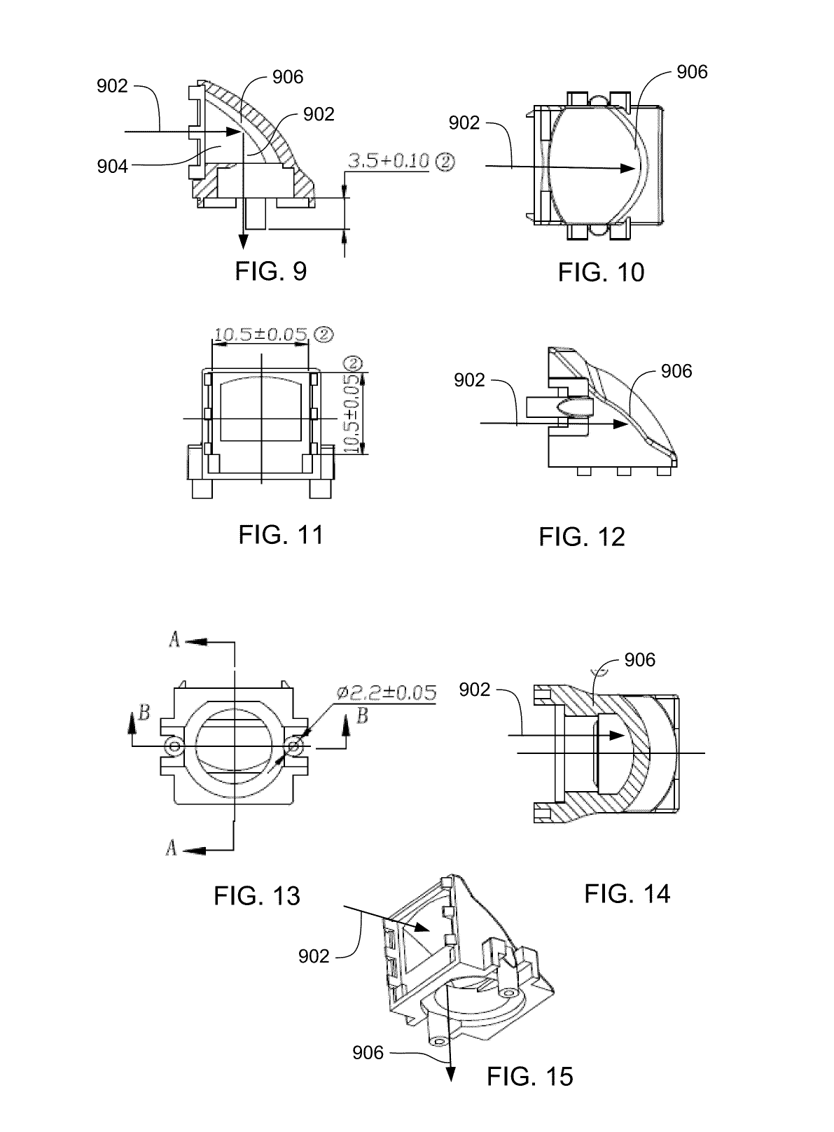

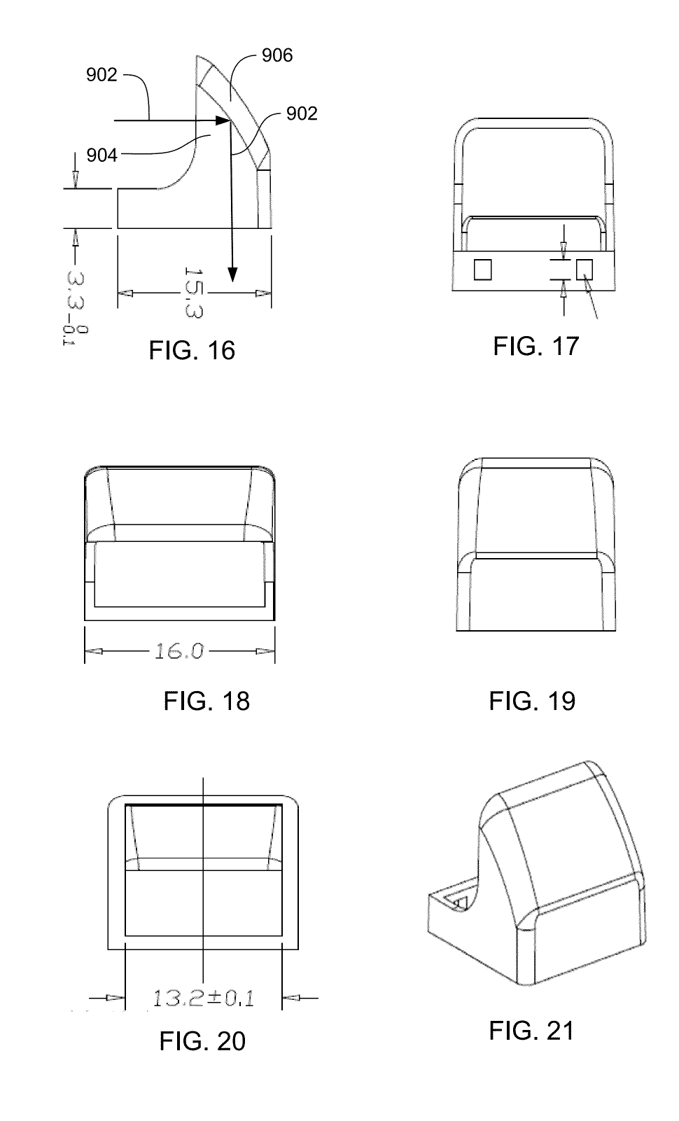

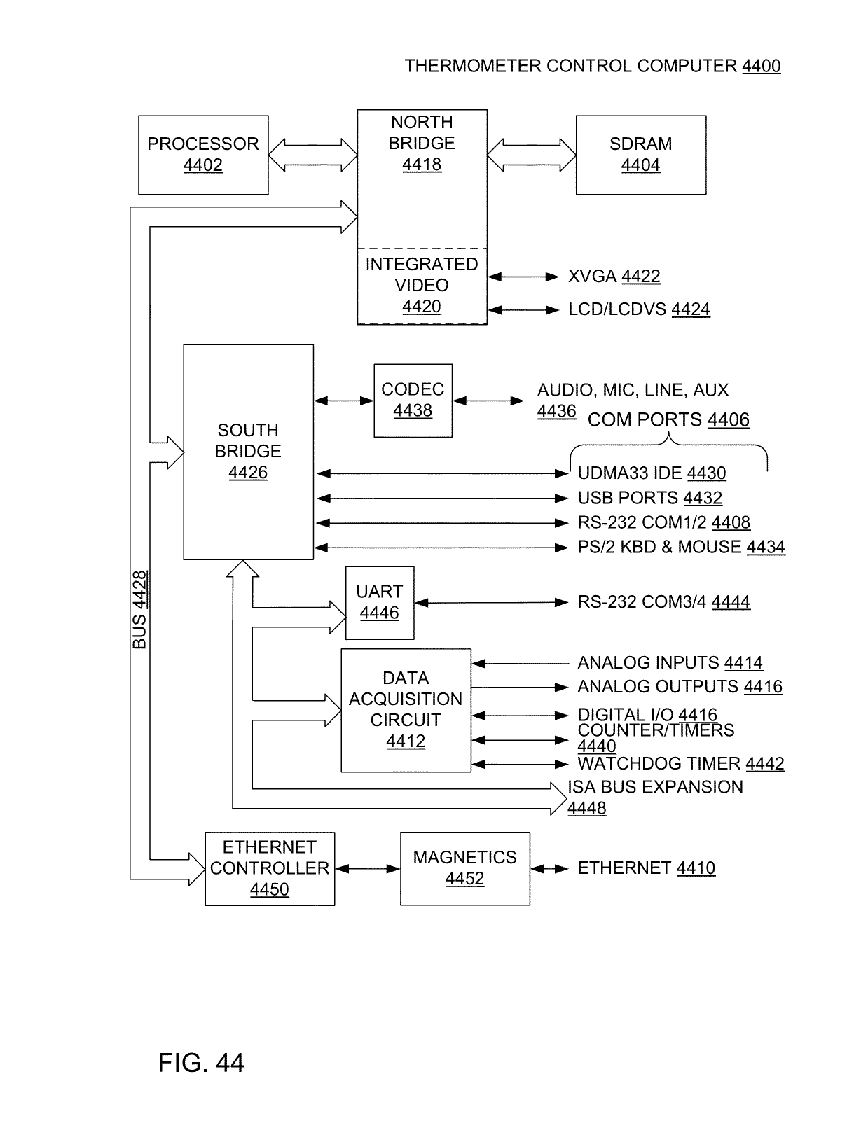

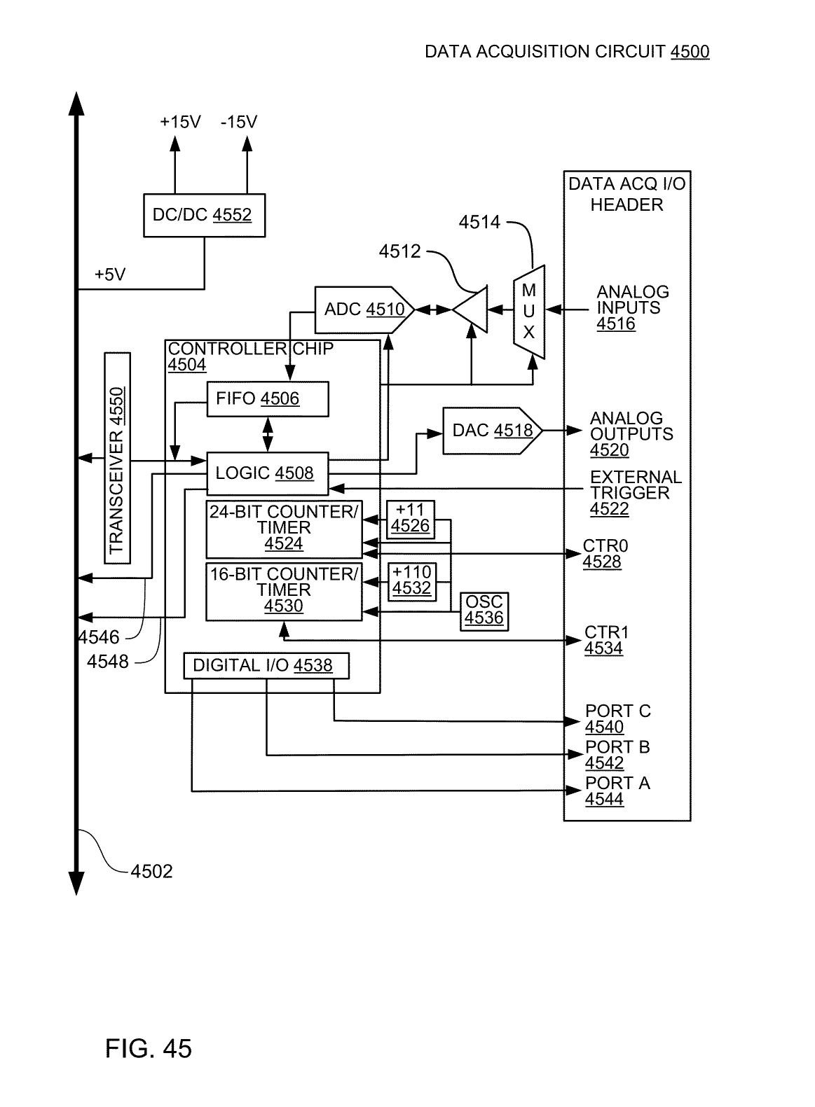

FIG. 9-15 are block diagrams of a sensor collector to guide electromagnetic energy to measure temperature, according to an implementation. FIG. 9 is a side cut-away view of the sensor collector to guide electromagnetic energy. The electromagnetic energy 902 enters the cavity 904 of the sensor collector and reflects off of the shroud 906 and through the bottom opening. The shroud 906 has in an inside surface that is concave. The shroud 906 is one example of the reflector 610 in FIG. 6. FIG. 44 is a top view of the sensor collector to guide electromagnetic energy. FIG. 45 is a front view of the sensor collector to guide electromagnetic energy. FIG. 12 is a side view of the sensor collector to guide electromagnetic energy. FIG. 13 is a bottom view of the sensor collector to guide electromagnetic energy. FIG. 14 is a top cut-away view of the sensor collector to guide electromagnetic energy. FIG. 15 is a bottom isometric view of the sensor collector to guide electromagnetic energy.

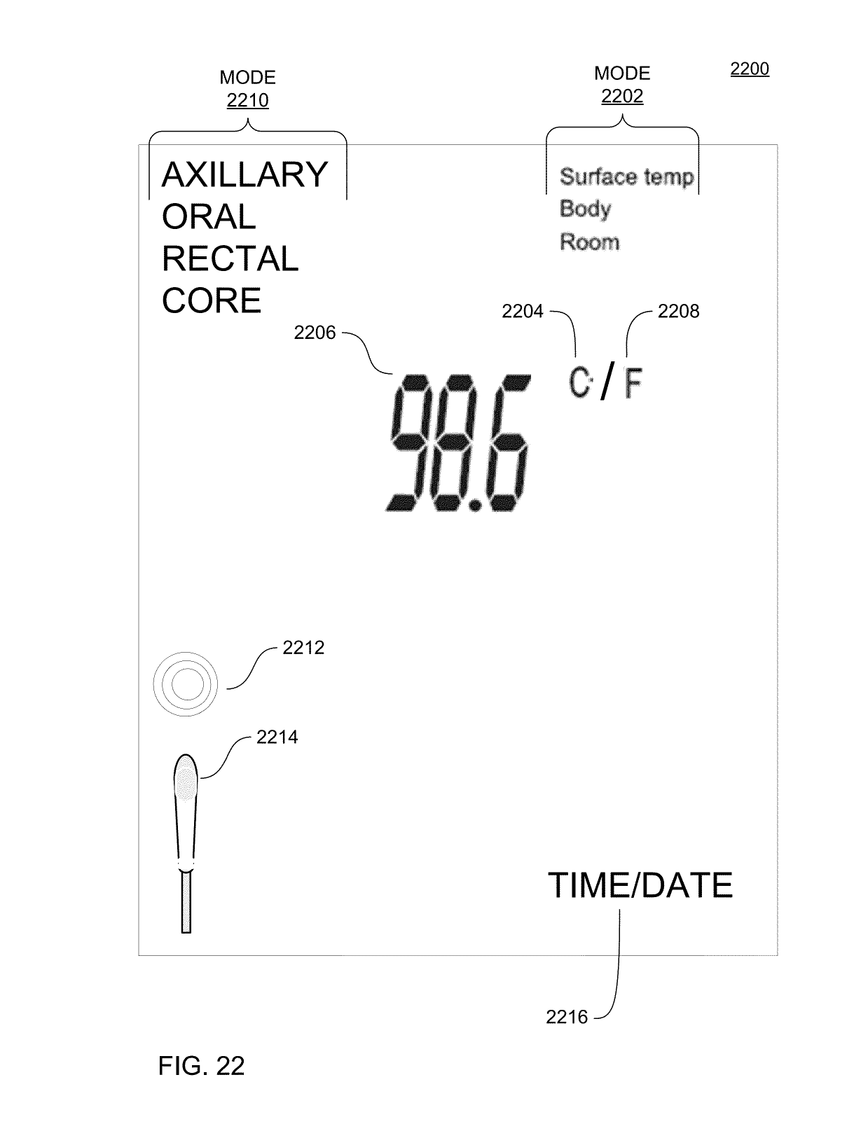

FIG. 16-21 are block diagrams of a shroud of a sensor collector to guide electromagnetic energy to measure temperature, according to an implementation. FIG. 16 is a side view of a shroud of a sensor collector to guide electromagnetic energy. The electromagnetic energy 902 enters the cavity 904 of the sensor collector and reflects off of the shroud 906 and through the bottom opening. FIG. 17 is a bottom view of a shroud of a sensor collector to guide electromagnetic energy. FIG. 18 is a front cut-away view of a shroud of a sensor collector to guide electromagnetic energy. FIG. 19 is a front view of a shroud of a sensor collector to guide electromagnetic energy. FIG. 20 is a front cut-away view of a shroud of a sensor collector to guide electromagnetic energy. FIG. 21 is a back top isometric view of a shroud of a sensor collector to guide electromagnetic energy.

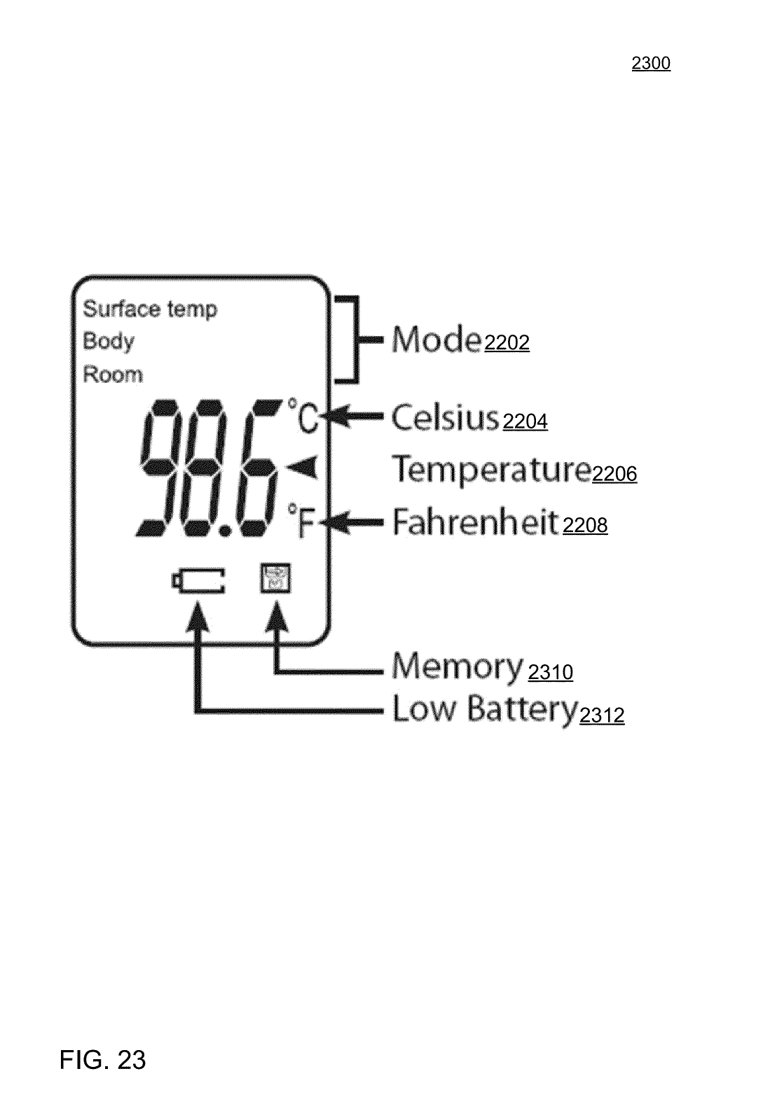

FIG. 22 is a representation of display that is presented on the display device of apparatus in FIG. 3-7, according to an implementation that manages both a non-contact sensor and a contact sensor.

Some implementations of display 2200 include a representation of three detection modes 2202, a first detection mode being detection and display of surface temperature, a second detection mode being detection and display of body temperature and a third detection mode being detection and display of room temperature.

Some implementations of display 2200 include a representation of Celsius 2204 that is activated when the apparatus is in Celsius mode.

Some implementations of display 2200 include a representation of a sensed temperature 2206.

Some implementations of display 2200 include a representation of Fahrenheit 2208 that is activated when the apparatus is in Fahrenheit mode.

Some implementations of display 2200 include a representation of a mode 2210 of site temperature sensing, a first site mode being detection of an axillary surface temperature, a second site mode being detection of an oral temperature, a third site mode being detection of a rectal temperature and a fourth site mode being detection of a core temperature.

Some implementations of display 2200 include a representation of a scanner mode 2212 that is activated when the sensed temperature 2206 is from a non-contact sensor 204.

Some implementations of display 2200 include a representation of a probe mode 2214 that is activated when the sensed temperature 2206 is from a contact sensor 218.

Some implementations of display 2200 include a representation of the current time/date 2216 of the apparatus.

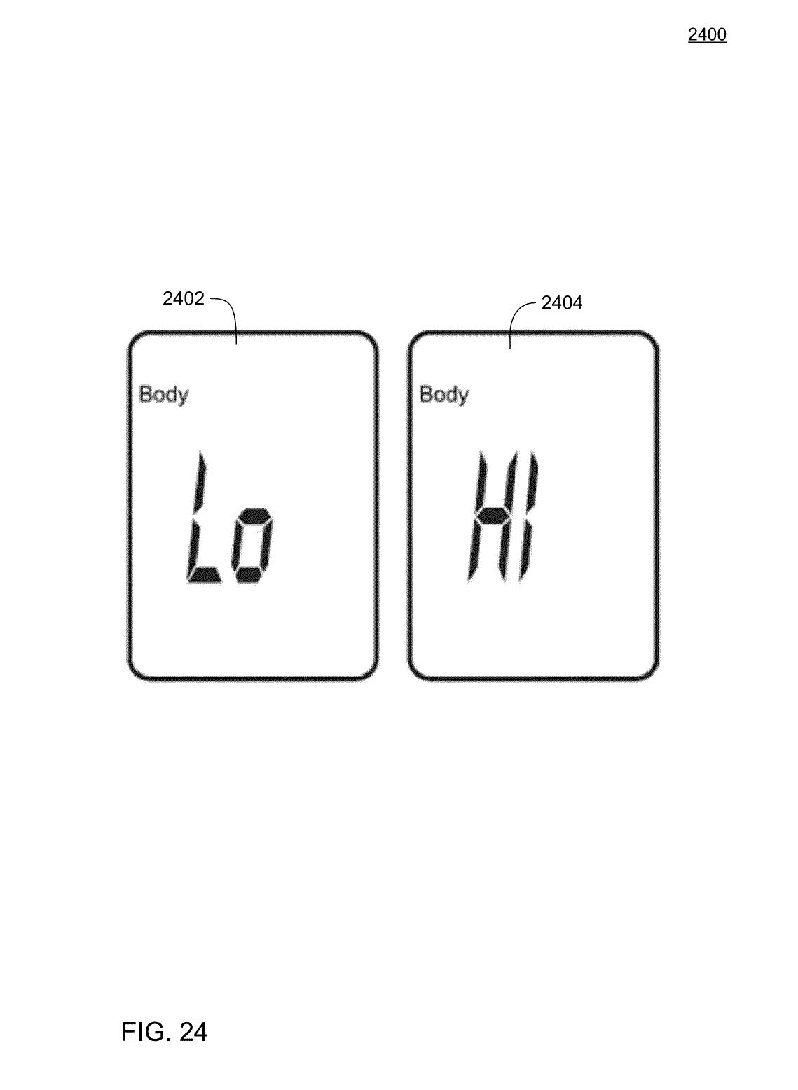

FIG. 23 is a representation of display 2300 that is presented on the display device of apparatus in FIG. 3-7, according to an implementation.

Some implementations of display 2300 include a representation of three detection modes 2202, a first detection mode being detection and display of surface temperature, a second detection mode being detection and display of body temperature and a third detection mode being detection and display of room temperature.

Some implementations of display 2300 include a representation of Celsius 2204 that is activated when the apparatus is in Celsius mode.

Some implementations of display 2300 include a representation of a temperature 2206.

Some implementations of display 2300 include a representation of Fahrenheit 2208 that is activated when the apparatus is in Fahrenheit mode.

Some implementations of display 2300 include a representation of memory 2310.

Some implementations of display 2300 include a representation of battery charge level 2312.

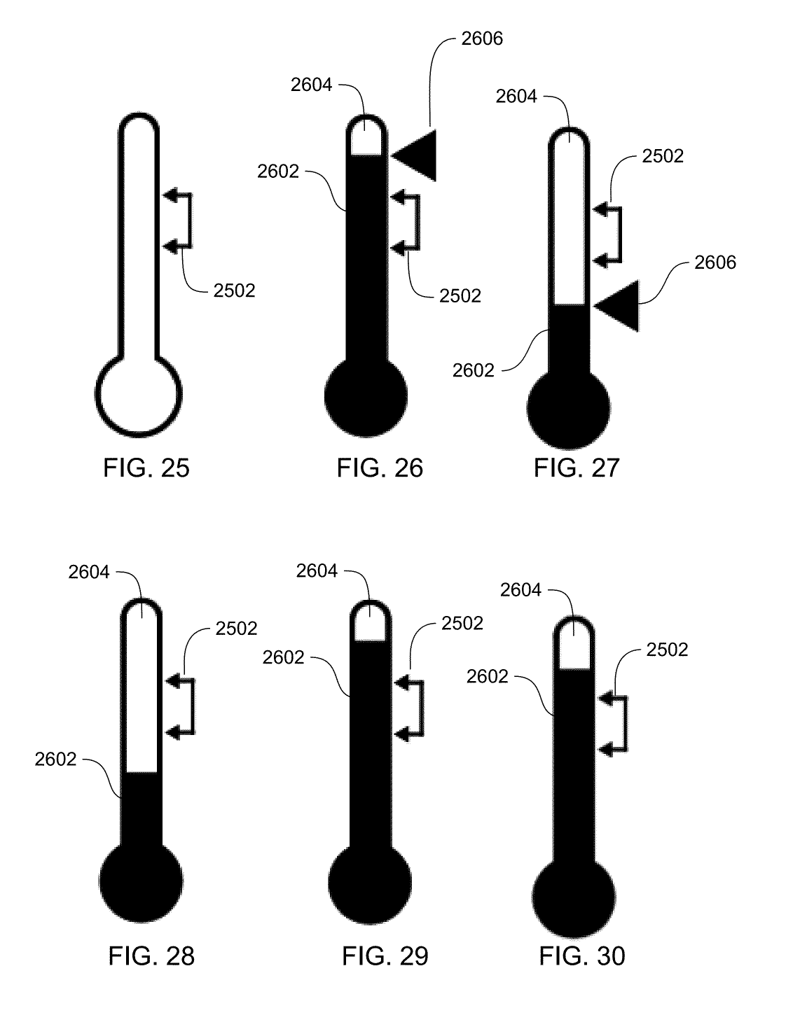

FIG. 24 is a representation of text displays 2400 that are presented on the display device of apparatus in FIG. 3-7, according to an implementation. Some implementations of display 2400 include a text representation that a sensed body temperature 2402 is “Lo” as in “low”. Some implementations of display 2400 include a text representation that a sensed body temperature 2404 is “Hi” as in “high”.

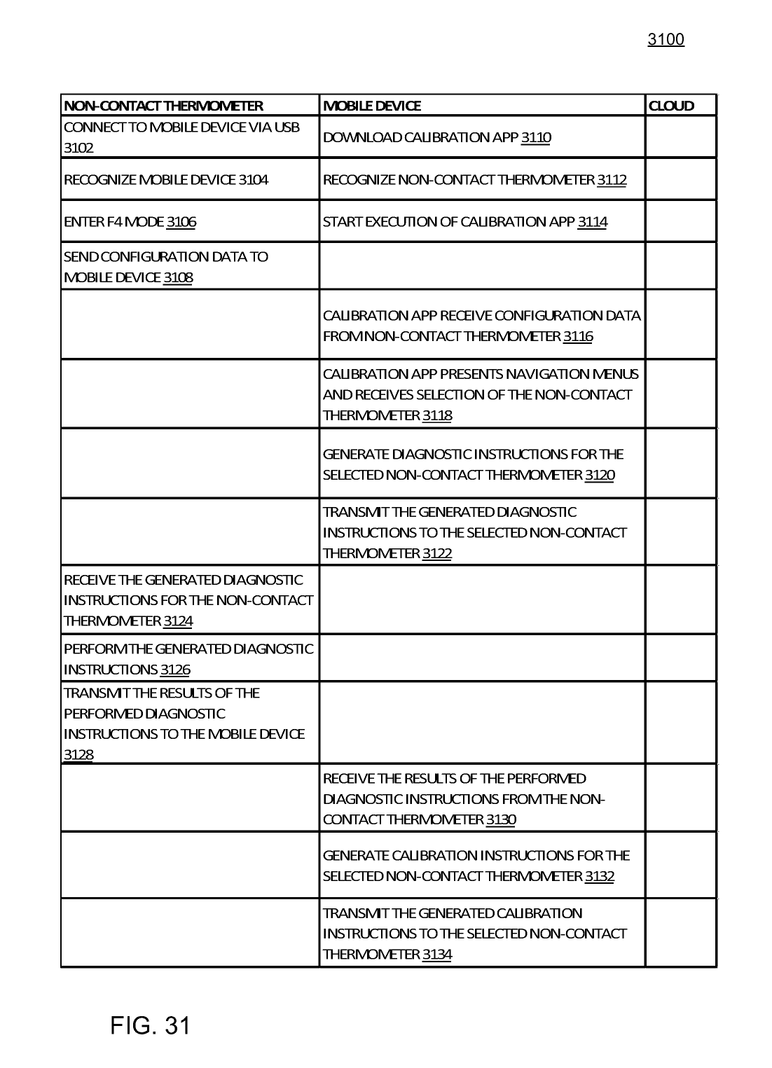

FIG. 25-30 are representations of graphical displays that are presented on the display device of apparatus in FIG. 3-7, according to implementations. The double-arrow bracket 2502 in FIG. 25-30 represents a general range of normal temperatures.

FIG. 25 is a graphical display that represents a state of having no sensed temperature. The empty thermometer in FIG. 25 indicates that no temperature sensing activity has completed.

FIG. 26 is a graphical display that represents a state of having sensed a high temperature. The thermometer in FIG. 26 having a contrasting color 2602 that is located above the general ranges of normal temperature indicates a higher than normal temperature. In FIG. 26-30, the contrasting color 2602 contrasts to the remainder 2604 of the interior of the thermometer image. In the example shown in FIG. 26-30, the contrasting color 2602 is black which contrasts with the white of the remainder 2604 of the interior of the thermometer image. FIG. 26 includes a pointer 2606 indicating the sensed temperature.

FIG. 27 is a graphical display that represents a state of having sensed a low temperature. The thermometer in FIG. 27 having only a contrasting color that is located below the general ranges of normal temperature indicates a lower than normal temperature. FIG. 27 includes a pointer 2606 indicating the sensed temperature.

FIG. 28 is a graphical display that represents a state of having sensed a low temperature. The thermometer in FIG. 28 having contrasting color located only below the general ranges of normal temperature indicates a lower than normal temperature.

FIG. 29 is a graphical display that represents a state of having sensed a high temperature. The thermometer in FIG. 29 having contrasting color that is located above the general ranges of normal temperature indicates a higher than normal temperature.

FIG. 30 is a graphical display that represents a state of having sensed a high temperature. The thermometer in FIG. 30 having contrasting color that is located above the general ranges of normal temperature indicates a higher than normal temperature.

Use Cases of Apparatus

In one example of use of the apparatus shown in FIG. 3-7, an operator performs a scan with the hand-held medical device, the operator determines that a contact temperature is helpful or necessary and the operator performs a reading with a contact sensor 218. In another example of use of the apparatus shown in FIG. 3-7, the operator performs a reading with the contact sensor 218, the operator determines that a non-contact temperature is helpful or necessary and the operator performs a scan with the hand-held medical device 204.

To perform a scan with the hand-held medical device 204, the operator uses a button to select one three modes of the apparatus, 1) oral 2) rectal or 4) axillary. The operator pushes the scan button 306 to initiate a non-contact temperature scan. The apparatus displays the detected temperature that is calculated in reference to the selected mode.

To determine that a contact temperature is helpful or necessary, the operator reviews the temperature displayed by the apparatus and determines that a temperature reading using a different technique, such as either contact or non-contact) would be informative.

To perform a reading with the contact sensor 218, the operator removes a contact sensor 218 probe from a receiver and places a disposable probe cover over the contact sensor 218, and the operator inserts the probe of the contact sensor 218 into the mouth of a human or animal. The apparatus senses in increase in temperature through the contact sensor 218 and in response the apparatus starts a timer. After expiration of the timer, the apparatus displays on the display device 304 the sensed temperature at the time of the timer expiration and generates an audio alert and in response the operator removes the probe of the contact sensor 218 from the mouth of the human or animal, places the probe of the contact sensor 218 into the receiver and reads the displayed temperature on the display device 304.

### Method Implementations

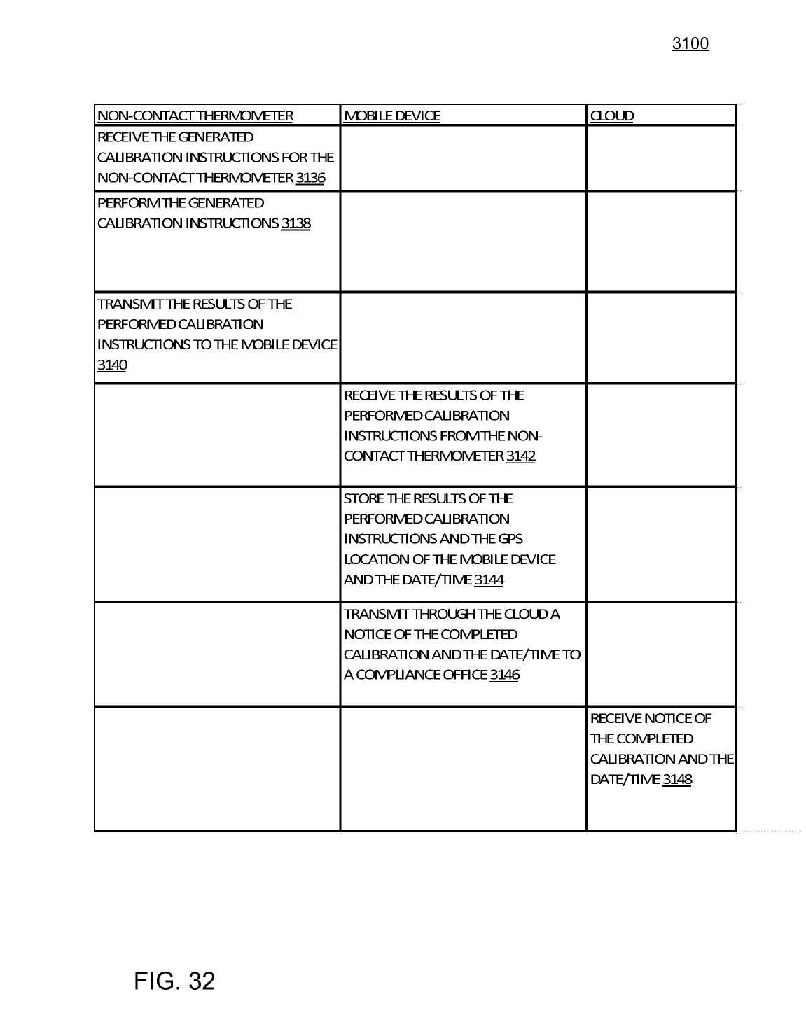

In the previous section, apparatus of the operation of an implementation was described. In this section, the particular methods performed by a hand-held medical device and a mobile device of such an implementation are described by reference to a series of flowcharts in FIG. 31-35. In this section, the particular methods performed by apparatus 300, 400, 600, 400 and 800 of such an implementation are described by reference to a series of flowcharts in FIG. 36-41.

FIG. 31-32 are a series of sequence diagrams of the interaction between a mobile device and a hand-held medical device, according to an implementation.

In FIG. 31, the hand-held medical device is connected to a mobile device via a wireless connection (such as a Bluetooth® wireless connection) or a USB cable or other cable, at block 3102. Bluetooth® is a proprietary open wireless technology standard for exchanging data over short distances (using short-wavelength radio transmissions in the ISM band from 2400-2480 MHz) from fixed and mobile devices, creating personal area networks (PANs) with high levels of security. Created by telecoms vendor Ericsson in 1994, Bluetooth® was originally conceived as a wireless alternative to RS-232 data cables. It can connect several devices, overcoming problems of synchronization. Bluetooth® uses a radio technology called frequency-hopping spread spectrum, which chops up the data being sent and transmits chunks of it on up to 79 bands (1 MHz each; centered from 2402 to 2480 MHz) in the range 2,400-2,483.5 MHz (allowing for guard bands). This range is in the globally unlicensed Industrial, Scientific and Medical (ISM) 2.4 GHz short-range radio frequency band. It usually performs 800 hops per second, with AFH enabled. Originally Gaussian frequency-shift keying (GFSK) modulation was the only modulation scheme available subsequently, since the introduction of Bluetooth 2.0+EDR, n/4-DQPSK and 8DPSK modulation may also be used between compatible devices. Devices functioning with GFSK are said to be operating in basic rate (BR) mode where an instantaneous data rate of 1 Mbit/s is possible. The term Enhanced Data Rate (EDR) is used to describe n/4-DPSK and 8DPSK schemes, each giving 2 and 3 Mbit/s respectively. The combination of these (BR and EDR) modes in Bluetooth® radio technology is classified as a “BR/EDR radio”. Bluetooth® is a packet-based protocol with a master-slave structure. One master may communicate with up to 7 slaves in a piconet; all devices share the master's clock. Packet exchange is based on the basic clock, defined by the master, which ticks at 312.5 μs intervals. Two clock ticks make up a slot of 625 μs; two slots make up a slot pair of 1250 μs. In the simple case of single-slot packets the master transmits in even slots and receives in odd slots; the slave, conversely, receives in even slots and transmits in odd slots. Packets may be 1, 3 or 5 slots long but in all cases the master transmit will begin in even slots and the slave transmit in odd slots. Bluetooth® provides a secure way to connect and exchange information between devices such as faxes, mobile phones, telephones, laptops, personal computers, printers, Global Positioning System (GPS) receivers, digital cameras, and video game consoles.

In FIG. 31, the hand-held medical device recognizes the mobile device, at block 3104.

In FIG. 31, the hand-held medical device enters a calibration and diagnostic mode, at block 3106.

In FIG. 31, the hand-held medical device sends configuration data to the mobile device, at block 3108. One example of the configuration data is configuration data 108 in FIG. 1.

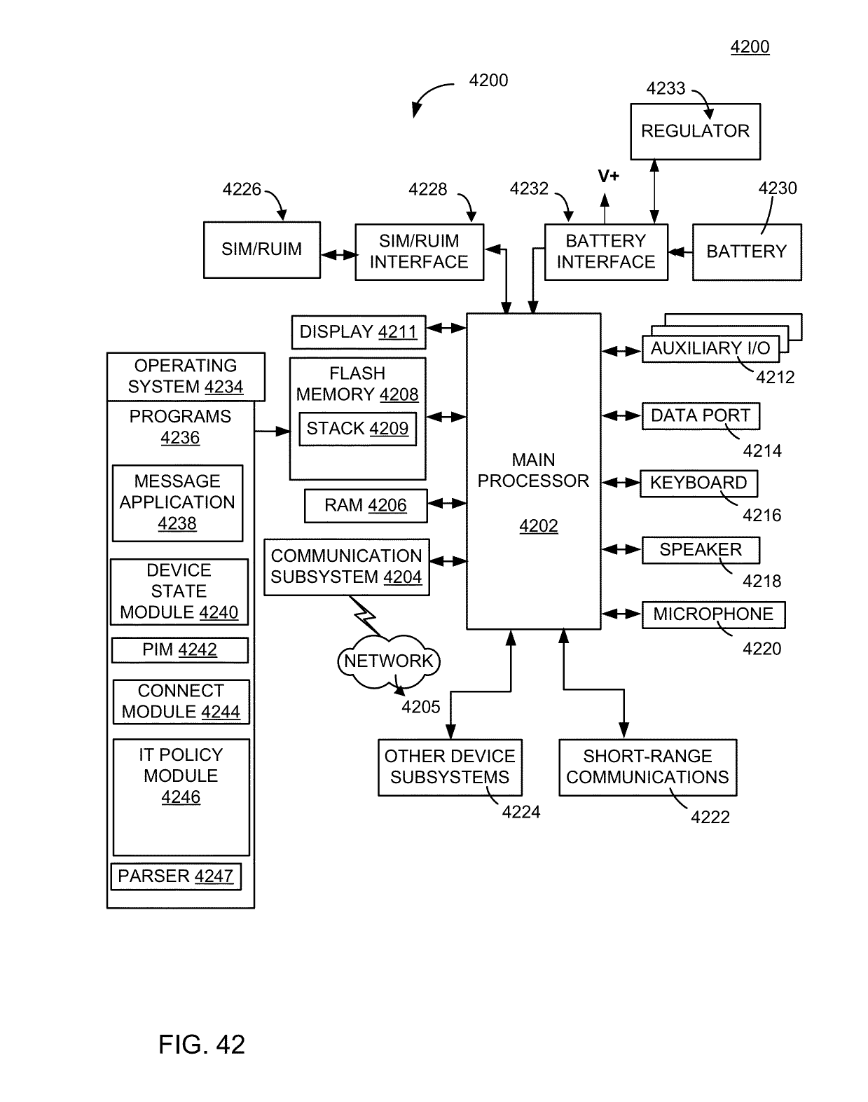

In FIG. 31, the mobile device downloads a calibration App, at block 3110. In general, an App of a mobile device is a software application that is executable on the mobile device. In some implementations, an app is stored on RAM 4206 or flash memory 4208 and executed (performed) by main processor 4202 in FIG. 42. The calibration App includes computer-executable instructions that

In FIG. 31, the mobile device recognizes the hand-held medical device, at block 3112.

In FIG. 31, the mobile device starts execution of the calibration App, at block 3114.

In FIG. 31, the calibration App of the mobile device receives configuration data from the hand-held medical device, at block 3116.

In FIG. 31, the calibration App of the mobile device presents navigation menus and receiving selection of the hand-held medical device, at block 3118.

In FIG. 31, the mobile device generates diagnostic instructions for the selected hand-held medical device, at block 3120. The diagnostic instructions are generated specifically for the hand-held medical device. One example of the diagnostic instructions are diagnostic instructions 110 in FIG. 1.

In FIG. 31, the mobile device transmits the generated diagnostic instructions to the selected hand-held medical device, at block 3122.

In FIG. 31, the hand-held medical device receives the generated diagnostic instructions for the hand-held medical device from the mobile device, at block 3124.

In FIG. 31, the hand-held medical device performing the generated diagnostic instructions, at block 3126. The performance of the generated diagnostic instructions yields diagnostic results. One example of the diagnostic results are the diagnostic results 112 in FIG. 1.

In FIG. 31, the hand-held medical device transmits the results of the performed diagnostic instructions to the mobile device, at block 3128.

In FIG. 31, the mobile device receives the results of the performed diagnostic instructions from the hand-held medical device, at block 3130. One example of the diagnostic results are the diagnostic results 112 in FIG. 1.

In FIG. 31, the mobile device generates calibration instructions for the selected hand-held medical device, at block 3132.

In FIG. 31, the mobile device transmits the generated calibration instructions to the selected hand-held medical device, at block 3134. One example of the calibration instructions are calibration instructions 114 in FIG. 1.

In FIG. 32, the hand-held medical device receives generated calibration instructions for the hand-held medical device from the mobile device, at block 3136. One example of the calibration instructions are calibration instructions 114 in FIG. 1.

In FIG. 32, the hand-held medical device performs the generated calibration instructions, yielding results of performed calibration instructions, at block 338. One example of the calibration results are the calibration results 116 in FIG. 1.

In FIG. 32, the hand-held medical device transmits the results of the performed calibration instructions to the mobile device, at block 3140.

In FIG. 32, the mobile device receives the results of the performed calibration instructions from the hand-held medical device, at block 3142. One example of the calibration results are the calibration results 116 in FIG. 1.

In FIG. 32, the mobile device stores the results of the performed calibration instructions and the GPS location of the mobile device and the date/time, at block 3144.

In FIG. 32, the mobile device transmits through the Cloud a notice of the completed calibration and the date/time to the compliance office, at block 3146.

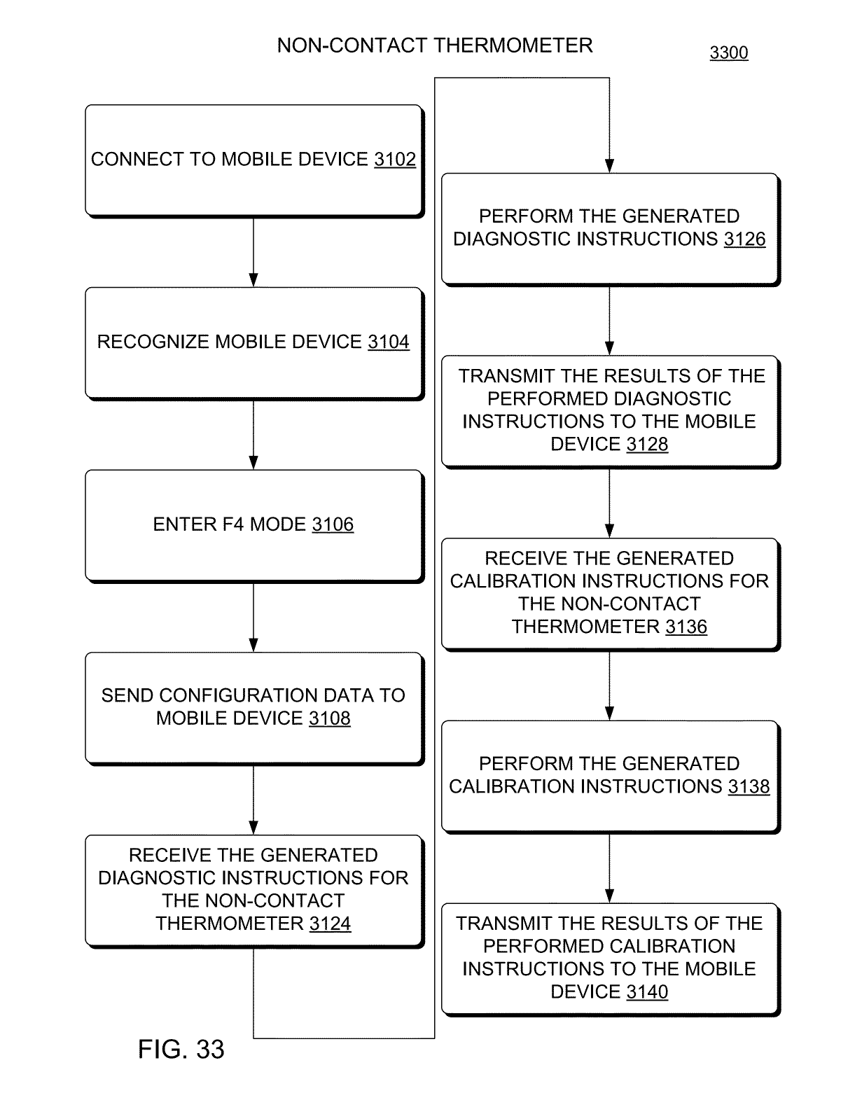

FIG. 33 is a flowchart of a method 3300 of calibrating a hand-held medical device that is in communication with a mobile device, the method 3300 performed by the hand-held medical device, according to an implementation. The hand-held medical device 104 is one example of the hand-held medical device in FIG. 33. The mobile device 106 is one example of the mobile device in FIG. 33.

In some implementations, method 3300 includes connecting to a mobile device via a wireless connection (such as a Bluetooth® wireless connection) or a USB cable or other cable, at block 3102.

In some implementations, method 3300 includes recognizing the mobile device, at block 3104.

In some implementations, method 3300 includes entering calibration and diagnostic mode, at block 3106.

In some implementations, method 3300 includes sending configuration data to the mobile device, at block 3108. One example of the configuration data is configuration data 108 in FIG. 1.

In some implementations, method 3300 includes receiving generated diagnostic instructions for the hand-held medical device from the mobile device, at block 3124. The diagnostic instructions are generated specifically for the hand-held medical device. One example of the diagnostic instructions are diagnostic instructions 110 in FIG. 1.

In some implementations, method 3300 includes the hand-held medical device performing the generated diagnostic instructions, at block 3126. The performance of the generated diagnostic instructions yields diagnostic results. One example of the diagnostic results are the diagnostic results 112 in FIG. 1.

In some implementations, method 3300 includes transmitting the results of the performed diagnostic instructions to the mobile device, at block 3128.

In some implementations, method 3300 includes receiving generated calibration instructions for the hand-held medical device from the mobile device, at block 3136. One example of the calibration instructions are calibration instructions 114 in FIG. 1.

In one example of the calibration instructions that includes manual steps follows:
1.
   Turn the hand-held medical device on
2. Set Mode to Surface Temp
3. Make temperature measurement of a Black body temperature
   a. Set and equilibrate the black body to the desired temperature (for example 30.039 C)
   b. Take a temperature measurement of the black body using the IR thermometer in “Surface Temp” mode
   c. Record reading
   d. If the thermometer reading does not match the black body temperature follow the steps in #3 to adjust the thermometer reading
4. Setting the thermometer to “Surface Temp Mode” using the calibration tool
   a. Receive indication that the operator of the device has pressed “Prog Setting” button and held 3 seconds until F1 is displayed
   b. Receive indication that the operator of the device has pressed “Prog Setting” button twice to go to F3
   c. Verify that F3 is set to “1” (Surface Temp) i. If “0” is displayed push the “+” button on the calibration tool
   d. Confirm the F3 setting by pressing the “Prog Setting” button
   e. Receive indication that the operator of the device has pressed “Prog Setting” button again to go to F4
   f. Receive indication that the operator of the device has pressed the “+” or “−” buttons on the calibration tool adjust the temperature reading. The buttons to increase or reduce the thermometer's temperature reading that will be displayed.
   g. When desired adjustment is reached, receiving confirmation of the operator pressing the “Prog Setting” button h. The display will go off and the device is ready to make temperature readings.
5. Repeat steps in #3 until the thermometer reading matches the black body temperature
6. Re-set thermometer back to “Body” before sending to next manufacturing step. Note: the IR thermometer is calibrated in the “Surface Temp” mode because it is used to measure the surface temperature of the black body. Do not carry out calibration in any other mode or body temperature measurements will be affected. Different algorithms are used to calculate the temperature displayed based on temperature measurement mode setting.

In some implementations, method 3300 includes performing the generated calibration instructions, yielding results of performed calibration instructions, at block 3138. One example of the calibration results are the calibration results 116 in FIG. 1.

In some implementations, method 3300 includes transmitting the results of the performed calibration instructions to the mobile device, at block 3140.

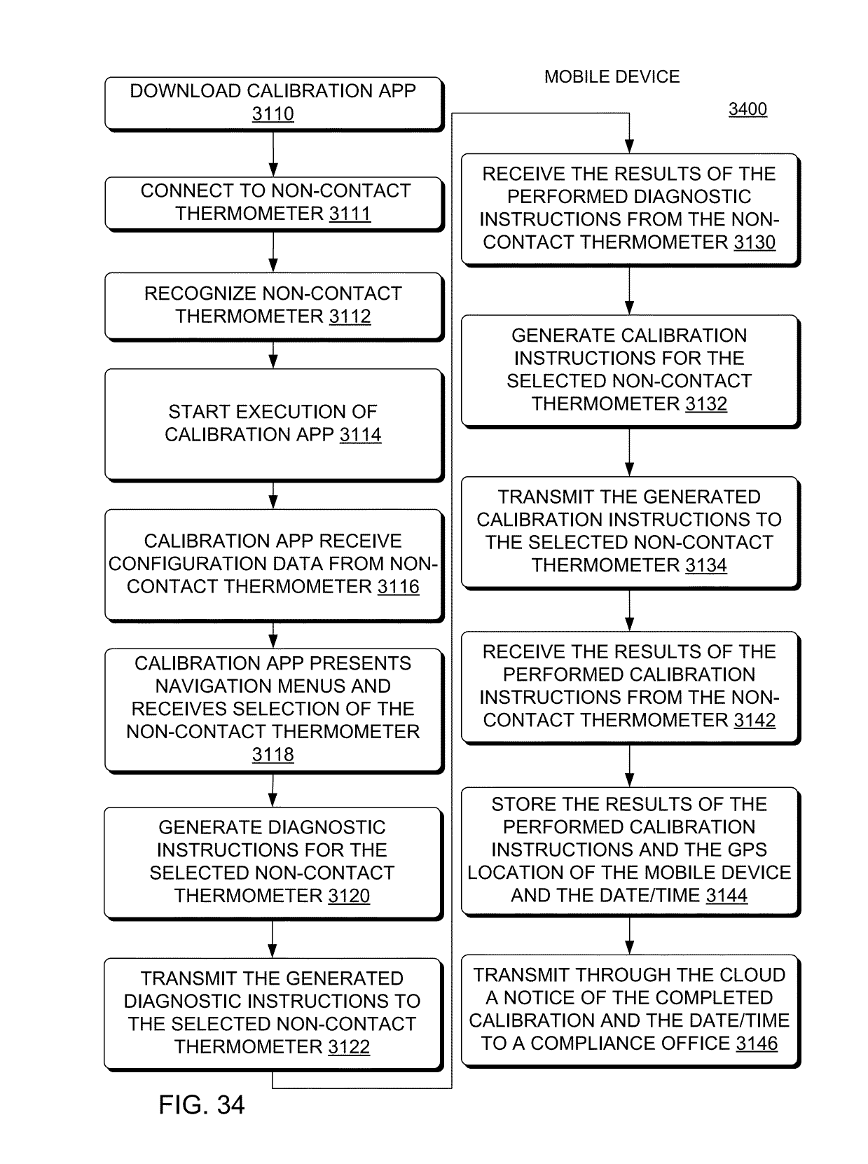

FIG. 34 is a flowchart of a method 3400 of calibrating a hand-held medical device that is in communication with a mobile device, the method 3400 is performed by the mobile device, according to an implementation.

In some implementations, method 3400 includes downloading a calibration App, at block 3110.

In some implementations, method 3400 includes connecting to the hand-held medical device via a wireless connection (such as a Bluetooth® wireless connection) or a USB cable or other cable, at block 3111.

In some implementations, method 3400 includes recognizing the hand-held medical device, at block 3112.

In some implementations, method 3400 includes starting execution of the calibration App, at block 3114.

In some implementations, method 3400 includes the calibration App receiving configuration data from hand-held medical device, at block 3116.

In some implementations, method 3400 includes the calibration App presenting navigation menus and receiving selection of the hand-held medical device, at block 3118.

In some implementations, method 3400 includes generating diagnostic instructions for the selected hand-held medical device, at block 3120. One example of the diagnostic instructions are diagnostic instructions 110 in FIG. 1.

In some implementations, method 3400 includes transmitting the generated diagnostic instructions to the selected hand-held medical device, at block 3122.

In some implementations, method 3400 includes receiving the results of the performed diagnostic instructions from the hand-held medical device, at block 3130. One example of the diagnostic results is the diagnostic results 112 in FIG. 1.

In some implementations, method 3400 includes generating calibration instructions for the selected hand-held medical device, at block 3132.

In some implementations, method 3400 includes transmitting the generated calibration instructions to the selected hand-held medical device, at block 3134. One example of the calibration instructions are calibration instructions 114 in FIG. 1.

In some implementations, method 3400 includes receiving the results of the performed calibration instructions from the hand-held medical device, at block 3142. One example of the calibration results are the calibration results 116 in FIG. 1.

In some implementations, method 3400 includes storing the results of the performed calibration instructions and the GPS location of the mobile device and the date/time, at block 3144.

In some implementations, method 3400 includes transmitting through the Cloud a notice of the completed calibration and the date/time to the compliance office, at block 3146.

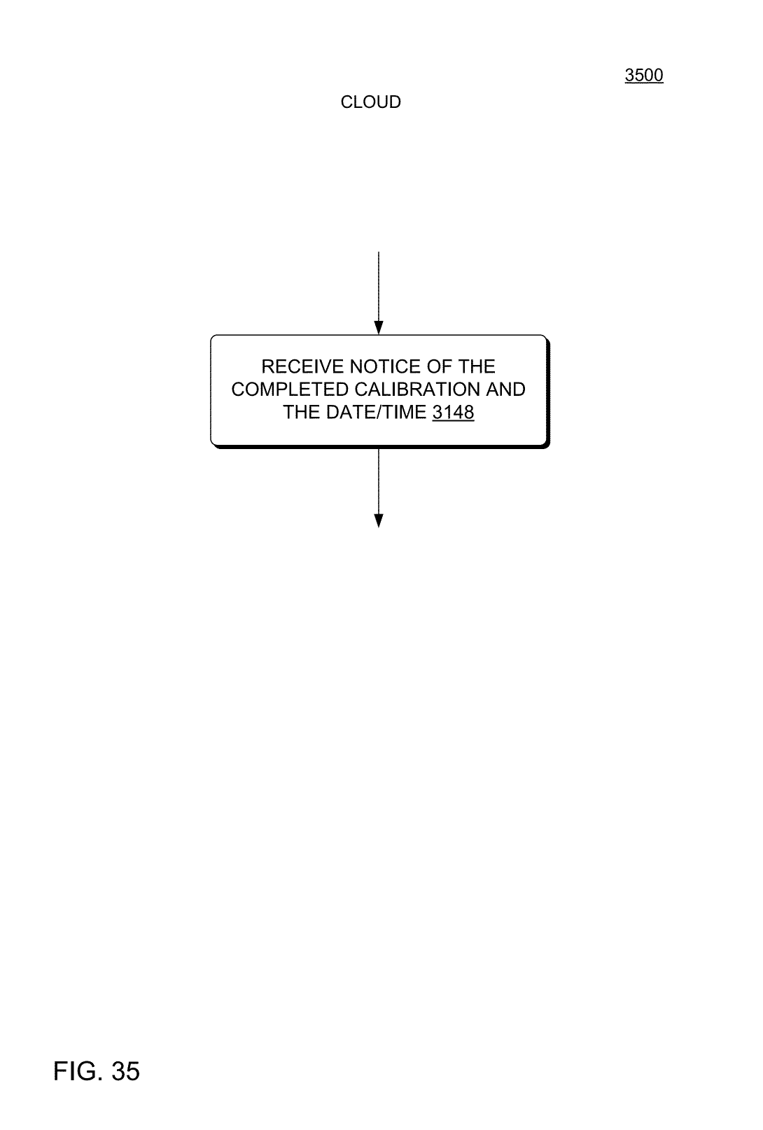

FIG. 35 is a flowchart of a method 3500 of a mobile device receiving notice of the completed calibration and the date/time of the hand-held medical device, at block 3148. The hand-held medical device 104 is one example of the hand-held medical device in FIG. 35. The mobile device 106 is one example of the mobile device in FIG. 34.

FIG. 36 is a flowchart of a method 3600 to measure temperature from multiple source points. Method 3600 includes sensing electromagnetic energy at a plurality of external source points on a subject, at block 3602. The sensing at block 3600 yields a sensed electromagnetic energy of the plurality of external source points. In one implementation, block 3602 includes sensing the electromagnetic energy from only at the carotid artery source point on the subject and sensing the electromagnetic energy at no other point on the subject.

Method 3600 also includes correlating a temperature of the subject from the sensed electromagnetic energy of the plurality of external source points, at block 3604. The correlating at block 3604 yields a correlated temperature. In some implementations, the correlating at block 3604 is performed by the multi-source temperature correlator 312 in FIG. 3. In some implementations, block 3604 includes correlating only the temperature of the subject from the sensed electromagnetic energy of the carotid artery source point on the subject. In one implementation, block 3604 includes correlating the electromagnetic energy from only the carotid artery source point on the subject and correlating the electromagnetic energy at no other point on the subject.

FIG. 37 is a flowchart of a method 3700 to measure temperature of a forehead and a carotid artery, according to an implementation. Method 3700 includes sensing the electromagnetic energy at the carotid artery source point on the subject and/or the forehead source point on the subject, at block 3702. In one implementation, block 3702 includes sensing the electromagnetic energy from only at the carotid artery source point on the subject and sensing the electromagnetic energy at no other point on the subject. The sensing at block 3702 yields the sensed electromagnetic energy of the external source point(s).

Method 3700 also includes correlating the temperature of the subject from the sensed electromagnetic energy of the carotid artery source point on the subject and/or from the forehead source point on the subject, at block 3704. The correlating at block 3704 yields a correlated temperature. In some implementations, block 3704 includes correlating only the temperature of the subject from the sensed electromagnetic energy of the carotid artery source point on the subject. In some implementations, the correlating at block 3704 is performed by the multi-source temperature correlator 312 in FIG. 3. In one implementation, block 3704 includes correlating the electromagnetic energy from only the carotid artery source point on the subject and correlating the electromagnetic energy at no other point on the subject.

In some implementations of method 3600 and 3700, the correlated temperature of the subject includes only a core temperature of the subject, an axillary temperature of the subject, a rectal temperature of the subject and an oral temperature of the subject. Methods 3600 and 3700 permit an operator to take the temperature of a subject at multiple locations on a patient and from the temperatures at multiple locations to determine the temperature at a number of other locations of the subject. The multiple source points of which the electromagnetic energy is sensed are mutually exclusive to the location of the correlated temperature. In one example, the carotid artery source point on the subject and a forehead source point are mutually exclusive to the core temperature of the subject, an axillary temperature of the subject, a rectal temperature of the subject and an oral temperature of the subject.

The correlation of action 3604 in FIG. 36 and action 3704 can include a calculation based on Formula 1:

T_{body}=|f_{stb}(T_{surface temp}+f_{ntc}(T_{ntc}))+F4_{body}| Formula 1
where T_{body} is the temperature of a body or subject
where f_{stb} is a mathematical formula of a surface of a body
where f_{ntc} is mathematical formula for ambient temperature reading
where T_{surface temp} is a surface temperature determined from the sensing 3602 in FIG. 3600 or 3702 in FIG. 37.
where T_{ntc} is an ambient air temperature reading
where F4_{body} is a calibration difference in axillary mode, which is stored or set in a memory of the apparatus either during manufacturing or in the field. The apparatus also sets, stores and retrieves F4ₒᵣₐₗ, F4_{core}, and F4_{rectal} in the memory.
f_{ntc}(T_{ntc}) is a bias in consideration of the temperature sensing mode. For example f_{axillary}(T_{axillary})=0.2° C., fₒᵣₐₗ(Tₒᵣₐₗ)=0.4° C., f_{rectal}(T_{rectal})=0.5° C. and f_{core}(T_{core})=0.3° C.

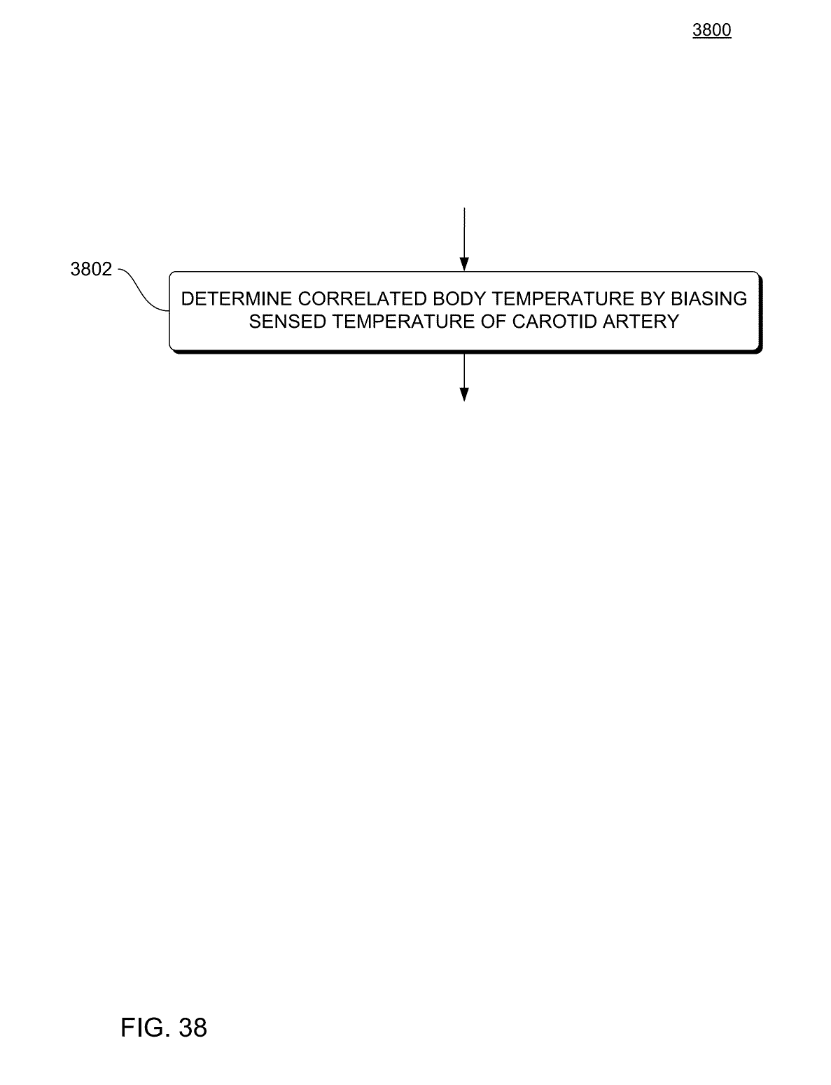

FIG. 38 is a flowchart of a method 3800 of a method of determining correlated body temperature of carotid artery, according to an implementation.

Method 3800 includes determining a correlated body temperature of carotid artery by biasing a sensed temperature of a carotid artery, at block 3802. In one example, the sensed temperature is biased by +0.5° C. to yield the correlated body temperature. In another example, the sensed temperature is biased by −0.5° C. to yield the correlated body temperature. Method 3800 in FIG. 37 is one example of block 3604 in FIG. 36 and block 3704 in FIG. 37. An example of correlating body temperature of a carotid artery follows:

f_{ntc}(T_{ntc})=0.2° C. when T_{ntc}=26.2° C. as retrieved from a data table for body sensing mode.

assumption: T_{surface temp}=37.8° C.

T_{surface temp}+f_{ntc}(T_{ntc})=37.8° C.+0.2° C.=38.0° C.

f_{stb}(T_{surface temp}+f_{ntc}(T_{ntc}))=38° C.+1.4° C.=39.4° C.

assumption: F4_{body}=0.5° C.

T_{body}=|f_{stb}(T_{surface temp}+f_{ntc}(T_{ntc}))+F4_{body}|=|39.4° C.+0.5 C|=39.9° C.

The correlated temperature for the carotid artery is 40.0° C.

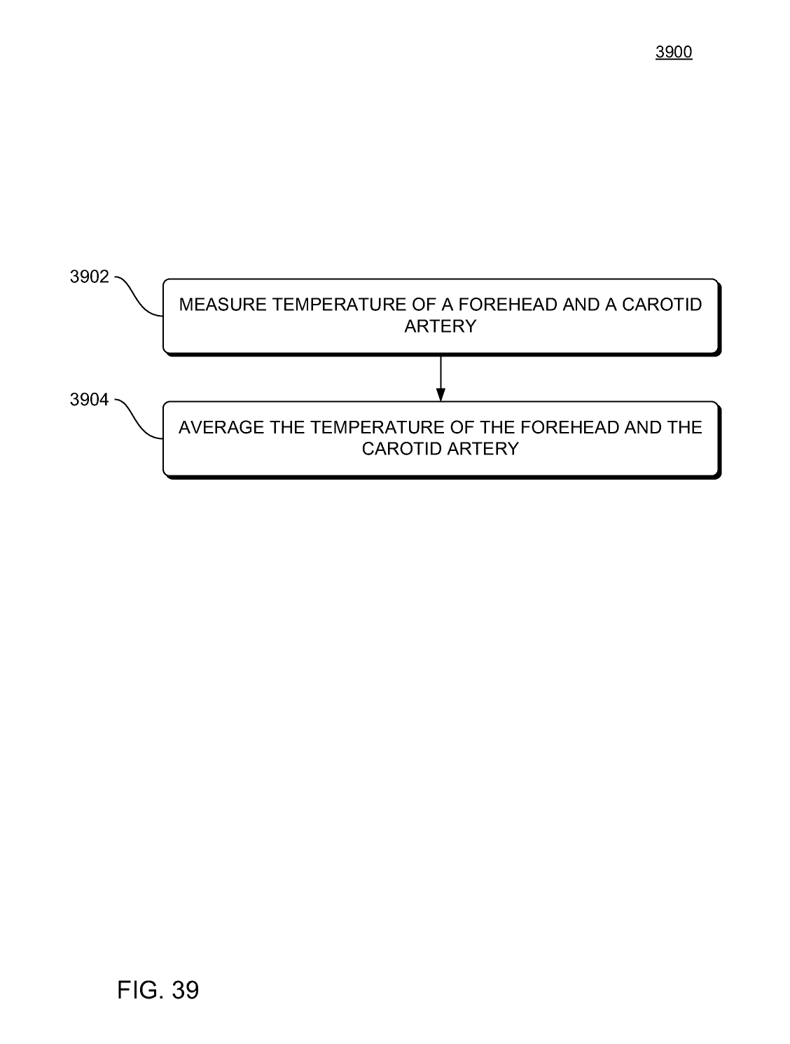

FIG. 39 is a flowchart of a method 3900 of forehead and carotid artery sensing, according to an implementation.

Method 3900 includes measuring temperature of a forehead and a carotid artery, at block 3902. Method 3600 in FIG. 36 is one example of block 3902. In an example of correlating temperature of a plurality of external locations, such as a forehead and a carotid artery to an axillary temperature, first a forehead temperature is calculated using formula 1 as follows:

f_{ntc}(T_{ntc})=0.2° C. when T_{ntc}=26.2° C. as retrieved from a data table for axillary sensing mode.

assumption: T_{surface temp}=37.8° C.

T_{surface temp}+f_{ntc}(T_{ntc})=37.8° C.+0.2° C.=38.0° C.

f_{stb}(T_{surface temp}+f_{ntc}(T_{ntc}))=38° C.+1.4° C.=39.4° C.

assumption: F4_{body}=0° C.

T_{body}=|f_{stb}(T_{surface temp}+f_{ntc}(T_{ntc}))+F4_{body}|=|39.4° C.+0 C|=39.4° C.

And second, a carotid temperature is calculated using formula 1 as follows:

f_{ntc}(T_{ntc})=0.6° C. when T_{ntc}=26.4° C. as retrieved from a data table.

assumption: T_{surface temp}=38.0° C.

T_{surface temp}+f_{ntc}(T_{ntc})=38.0° C.+0.6° C.=38.6° C.

f_{stb}(T_{surface temp}+f_{ntc}(T_{ntc}))=38.6° C.+1.4 C=40.0° C.

assumption: F4_{body}=0° C.

T_{body}=|f_{stb}(T_{surface temp}+f_{ntc}(T_{ntc}))+F4_{body}|=|40.0° C.+0 C|=40.0° C.

Thereafter the correlated temperature for the forehead (39.4° C.) and the correlated temperature for the carotid artery (40.0° C.) are averaged, at block 3904, yielding the final result of the scan of the forehead and the carotid artery as 39.7° C.

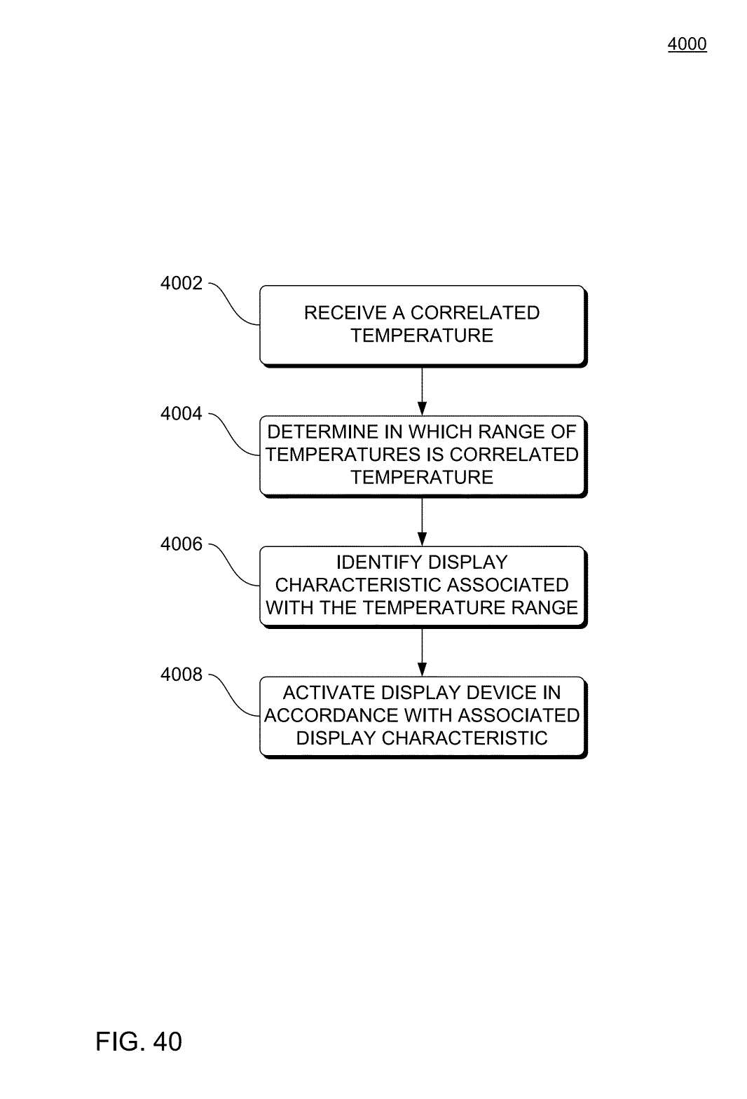

FIG. 40 is a flowchart of a method 4000 to display temperature color indicators, according to an implementation. Method 4000 provides color rendering in the display device 104 to indicate a general range of a correlated temperature.

Method 4000 includes receiving a correlated temperature, at block 4002. The correlated temperature can be received from the non-contact sensor 310 or the contact sensor 512, or the correlated temperature can be received from a printed circuit board that has adjusted a temperature in reference to either the site on the human or animal of the temperature sensing and or the ambient temperature detected in the vicinity of the apparatus performing the method 4000.

Method 4000 also includes determining in which of a plurality of ranges is the correlated temperature, at block 4004.

Method 4000 also includes identifying a display characteristic that is associated with the determined temperature range, at block 4006. In some implementations, the display characteristic is a color of text. In some implementations, the display characteristic is an image such as a commercial advertisement image.

Method 4000 also includes activating the display device 304 in accordance with the identified display characteristic, at block 4008. In the implementations in which the display characteristic is a color of text, method 4000 provides color rendering in the display device 304 to indicate the general range of the sensed temperature. The medical significance of the temperature is indicated by the displayed color. In the implementations in which the display characteristic is an image such as a commercial advertisement image, method 4000 provides advertising that is relevant to the medical condition of a patient.

In one implementation of a method to display temperature color indicators, according to an implementation of two colors, the method includes the non-contact sensor (such as 204 in FIG. 2) yielding a sensed temperature that is correlated and color changes of the display device (such as 304 in FIG. 3) are related to the correlated temperature, and the display device activates pixels in at least two colors, the colors being in accordance with the correlated temperature.

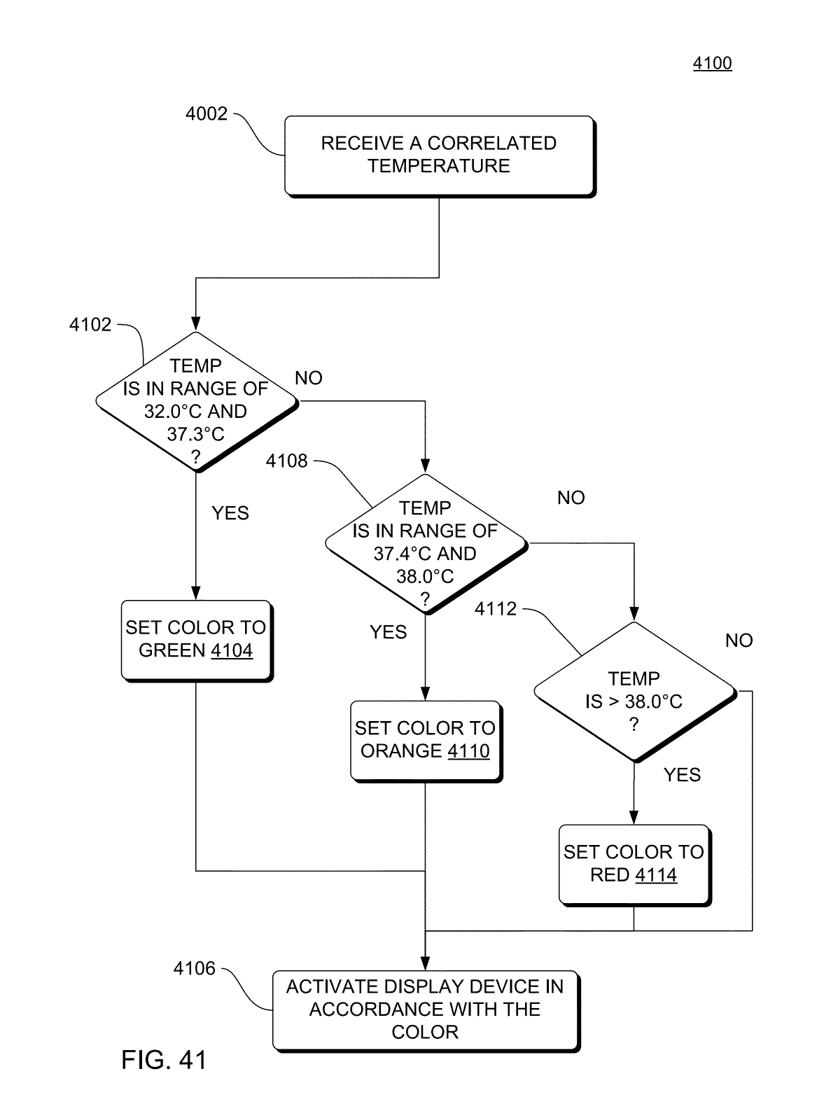

FIG. 41 is a flowchart of a method 4100 to display temperature color indicators, according to an implementation of three colors. Method 4100 provides color rendering in the display device 304 to indicate a general range of a correlated temperature.

Method 4100 includes receiving a correlated temperature, at block 1702. The correlated temperature can be received from the non-contact sensor 204 or the contact sensor 512, or the correlated temperature can be received from a printed circuit board that has adjusted a temperature in reference to either the site on the human or animal of the temperature sensing and or the ambient temperature detected in the vicinity of the apparatus performing the method 4100.

Method 4100 also includes determining whether or not the correlated temperature is in the range of 32.0° C. and 37.3° C., at block 4102. If the correlated temperature is in the range of 32.0° C. and 37.3° C., then the color is set to ‘green’ to indicate a temperature of no medical concern, at block 4104 and the background of the display device 304 is activated in accordance with the color, at block 4106.

If the correlated temperature is not the range of 32.0° C. and 37.3° C., then method 4100 also includes determining whether or not the correlated temperature is in the range of 37.4° C. and 38.0° C., at block 4108. If the sensed temperature is in the range of 37.4° C. and 38.0° C., then the color is set to ‘orange’ to indicate caution, at block 4110 and the background of the display device 304 is activated in accordance with the color, at block 4106.

If the correlated temperature is not the range of 37.4° C. and 38.0° C., then method 4100 also includes determining whether or not the correlated temperature is over 38.0° C., at block 4112. If the correlated temperature is over 38.0° C., then the color is set to ‘red’ to indicate alert, at block 4112 and the background of the display device 304 is activated in accordance with the color, at block 4106.

Method 4100 assumes that temperature is correlated in gradients of 10ths of a degree. Other temperature range boundaries are used in accordance with other gradients of temperature sensing.

In some implementations, some pixels in the display device 304 are activated as a green color when the correlated temperature is between 36.3° C. and 37.3° C. (97.3° F. to 99.1° F.), some pixels in the display device 304 are activated as an orange color when the correlated temperature is between 37.4° C. and 37.9° C. (99.3° F. to 100.2° F.), some pixels in the display device 304 are activated as a red color when the correlated temperature is greater than 38° C. (100.4° F.). In some implementations, the display device 304 is a backlit LCD screen (which is easy to read in a dark room) and some pixels in the display device 304 are activated (remain lit) for about 5 seconds after the button 304 is released. After the display device 304 has shut off, another temperature reading can be taken by the apparatus. The color change of the display device 304 is to alert the user of the apparatus of a potential increase of body temperature of the human or animal subject. Temperature reported on the display can be used for treatment decisions.

In some implementations, methods 3300-4100 are implemented as a sequence of instructions which, when executed by a processor 4402 in FIG. 44, cause the processor to perform the respective method. In other implementations, methods 3300-700 are implemented as a computer-accessible medium having executable instructions capable of directing a processor, such as processor 4402 in FIG. 44, to perform the respective method. In varying implementations, the medium is a magnetic medium, an electronic medium, or an optical medium.

### Hardware and Operating Environment

The implementations described herein generally relate to a mobile wireless communication device, hereafter referred to as a mobile device, which can be configured according to an IT policy. It should be noted that the term IT policy, in general, refers to a collection of IT policy rules, in which the IT policy rules can be defined as being either grouped or non-grouped and global or per-user. The terms grouped, non-grouped, global and per-user are defined further below. Examples of applicable communication devices include pagers, cellular phones, cellular smart-phones, wireless organizers, personal digital assistants, computers, laptops, handheld wireless communication devices, wirelessly enabled notebook computers and the like.

FIG. 42 is a block diagram of a mobile device 4200, according to an implementation. The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

Mobile device 4200 is one implementation of mobile device 106 in FIG. 1. The mobile device 4200 includes a number of components such as a main processor 4202 that controls the overall operation of the mobile device 4200. Communication functions, including data and voice communications, are performed through a communication subsystem 4204. The communication subsystem 4204 receives messages from and sends messages to wireless networks 4205. Other implementations of the mobile device 4200, the communication subsystem 4204 can be configured in accordance with the Global System for Mobile Communication (GSM), General Packet Radio Services (GPRS), Enhanced Data GSM Environment (EDGE), Universal Mobile Telecommunications Service (UMTS), data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include Mobitex™ and DataTAC™ network communication systems. Examples of other voice-centric data networks include Personal Communication Systems (PCS) networks like GSM and Time Division Multiple Access (TDMA) systems.

The wireless link connecting the communication subsystem 4204 with the wireless network 4205 represents one or more different Radio Frequency (RF) channels. With newer network protocols, these channels are capable of supporting both circuit switched voice communications and packet switched data communications.

The main processor 4202 also interacts with additional subsystems such as a Random Access Memory (RAM) 4206, a flash memory 4208, a display 4210, an auxiliary input/output (I/O) subsystem 4212, a data port 4214, a keyboard 4216, a speaker 4218, a microphone 4220, short-range communications 4222 and other device subsystems 4224. The configuration data 108, the diagnostic results 112 and the calibration results 116 is received by the communication subsystem 4204 and transferred by the main processor 4202 to the flash memory 4208. The diagnostic instructions 110 and the calibration instructions 114 is also transferred by the main processor 4202 from the flash memory 4208 through the cable 102.

Some of the subsystems of the mobile device 4200 perform communication-related functions, whereas other subsystems may provide “resident” or on-device functions. By way of example, the display 4210 and the keyboard 4216 may be used for both communication-related functions, such as entering a text message for transmission over the wireless network 4205, and device-resident functions such as a calculator or task list.

The mobile device 4200 can transmit and receive communication signals over the wireless network 4205 after required network registration or activation procedures have been completed. Network access is associated with a subscriber or user of the mobile device 4200. To identify a subscriber, the mobile device 4200 requires a SIM/RUIM card 4226 (i.e. Subscriber Identity Module or a Removable User Identity Module) to be inserted into a SIM/RUIM interface 4228 in order to communicate with a network. The SIM card or RUIM 4226 is one type of a conventional “smart card” that can be used to identify a subscriber of the mobile device 4200 and to personalize the mobile device 4200, among other things. Without the SIM card 4226, the mobile device 4200 is not fully operational for communication with the wireless network 4205. By inserting the SIM card/RUIM 4226 into the SIM/RUIM interface 4228, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 4226 includes a processor and memory for storing information. Once the SIM card/RUIM 4226 is inserted into the SIM/RUIM interface 4228, it is coupled to the main processor 4202. In order to identify the subscriber, the SIM card/RUIM 4226 can include some user parameters such as an International Mobile Subscriber Identity (IMSI). An advantage of using the SIM card/RUIM 4226 is that a subscriber is not necessarily bound by any single physical mobile device. The SIM card/RUIM 4226 may store additional subscriber information for a mobile device as well, including datebook (or calendar) information and recent call information. Alternatively, user identification information can also be programmed into the flash memory 4208.

The mobile device 4200 is a battery-powered device and includes a battery interface 4232 for receiving one or more rechargeable batteries 4230. In one or more implementations, the battery 4230 can be a smart battery with an embedded microprocessor. The battery interface 4232 is coupled to a regulator 4233, which assists the battery 4230 in providing power V+ to the mobile device 4200. Although current technology makes use of a battery, future technologies such as micro fuel cells may provide the power to the mobile device 4200.

The mobile device 4200 also includes an operating system 4234 and software components 4236 to 4246 which are described in more detail below. The operating system 4234 and the software components 4236 to 4246 that are executed by the main processor 4202 are typically stored in a persistent store such as the flash memory 4208, which may alternatively be a read-only memory (ROM) or similar storage element (not shown). Those skilled in the art will appreciate that portions of the operating system 4234 and the software components 4236 to 4246, such as specific device applications, or parts thereof, may be temporarily loaded into a volatile store such as the RAM 4206. Other software components can also be included.

The subset of software applications 4236 that control basic device operations, including data and voice communication applications, will normally be installed on the mobile device 4200 during its manufacture. Other software applications include a message application 4238 that can be any suitable software program that allows a user of the mobile device 4200 to transmit and receive electronic messages. Various alternatives exist for the message application 4238 as is well known to those skilled in the art. Messages that have been sent or received by the user are typically stored in the flash memory 4208 of the mobile device 4200 or some other suitable storage element in the mobile device 4200. In one or more implementations, some of the sent and received messages may be stored remotely from the device 4200 such as in a data store of an associated host system with which the mobile device 4200 communicates.

The software applications can further include a device state module 4240, a Personal Information Manager (PIM) 4242, and other suitable modules (not shown). The device state module 4240 provides persistence, i.e. the device state module 4240 ensures that important device data is stored in persistent memory, such as the flash memory 4208, so that the data is not lost when the mobile device 4200 is turned off or loses power.

The PIM 4242 includes functionality for organizing and managing data items of interest to the user, such as, but not limited to, e-mail, contacts, calendar events, voice mails, appointments, and task items. A PIM application has the ability to transmit and receive data items via the wireless network 4205. PIM data items may be seamlessly integrated, synchronized, and updated via the wireless network 4205 with the mobile device subscriber's corresponding data items stored and/or associated with a host computer system. This functionality creates a mirrored host computer on the mobile device 4200 with respect to such items. This can be particularly advantageous when the host computer system is the mobile device subscriber's office computer system.

The mobile device 4200 also includes a connect module 4244, and an IT policy module 4246. The connect module 4244 implements the communication protocols that are required for the mobile device 4200 to communicate with the wireless infrastructure and any host system, such as an enterprise system, with which the mobile device 4200 is authorized to interface. Examples of a wireless infrastructure and an enterprise system are given in FIGS. 21 and 22, which are described in more detail below.

The connect module 4244 includes a set of APIs that can be integrated with the mobile device 4200 to allow the mobile device 4200 to use any number of services associated with the enterprise system. The connect module 4244 allows the mobile device 4200 to establish an end-to-end secure, authenticated communication pipe with the host system. A subset of applications for which access is provided by the connect module 4244 can be used to pass IT policy commands from the host system to the mobile device 4200. This can be done in a wireless or wired manner. These instructions can then be passed to the IT policy module 4246 to modify the configuration of the device 4200. Alternatively, in some cases, the IT policy update can also be done over a wired connection.

The IT policy module 4246 receives IT policy data that encodes the IT policy. The IT policy module 4246 then ensures that the IT policy data is authenticated by the mobile device 4200. The IT policy data can then be stored in the flash memory 4206 in its native form. After the IT policy data is stored, a global notification can be sent by the IT policy module 4246 to all of the applications residing on the mobile device 4200. Applications for which the IT policy may be applicable then respond by reading the IT policy data to look for IT policy rules that are applicable.

The IT policy module 4246 can include a parser 4247, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 4246 can determine which applications are affected by the IT policy data and transmit a notification to only those applications. In either of these cases, for applications that are not being executed by the main processor 4202 at the time of the notification, the applications can call the parser or the IT policy module 4246 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 4246 sends an acknowledgement back to the host system to indicate that the IT policy data was received and successfully applied.

Other types of software applications can also be installed on the mobile device 4200. These software applications can be third party applications, which are added after the manufacture of the mobile device 4200. Examples of third party applications include games, calculators, utilities, etc.

The additional applications can be loaded onto the mobile device 4200 through at least one of the wireless network 4205, the auxiliary I/O subsystem 4212, the data port 4214, the short-range communications subsystem 4222, or any other suitable device subsystem 4224. This flexibility in application installation increases the functionality of the mobile device 4200 and may provide enhanced on-device functions, communication-related functions, or both. For example, secure communication applications may enable electronic commerce functions and other such financial transactions to be performed using the mobile device 4200.

The data port 4214 enables a subscriber to set preferences through an external device or software application and extends the capabilities of the mobile device 4200 by providing for information or software downloads to the mobile device 4200 other than through a wireless communication network. The alternate download path may, for example, be used to load an encryption key onto the mobile device 4200 through a direct and thus reliable and trusted connection to provide secure device communication.

The data port 4214 can be any suitable port that enables data communication between the mobile device 4200 and another computing device. The data port 4214 can be a serial or a parallel port. In some instances, the data port 4214 can be a USB port that includes data lines for data transfer and a supply line that can provide a charging current to charge the battery 4230 of the mobile device 4200.

The short-range communications subsystem 4222 provides for communication between the mobile device 4200 and different systems or devices, without the use of the wireless network 4205. For example, the subsystem 4222 may include an infrared device and associated circuits and components for short-range communication. Examples of short-range communication standards include standards developed by the Infrared Data Association (IrDA), Bluetooth, and the 4202.11 family of standards developed by IEEE.

In use, a received signal such as a text message, an e-mail message, or web page download will be processed by the communication subsystem 4204 and input to the main processor 4202. The main processor 4202 will then process the received signal for output to the display 4210 or alternatively to the auxiliary I/O subsystem 4212. A subscriber may also compose data items, such as e-mail messages, for example, using the keyboard 4216 in conjunction with the display 4210 and possibly the auxiliary I/O subsystem 4212. The auxiliary subsystem 4212 may include devices such as: a touch screen, mouse, track ball, infrared fingerprint detector, or a roller wheel with dynamic button pressing capability. The keyboard 4216 is preferably an alphanumeric keyboard and/or telephone-type keypad. However, other types of keyboards may also be used. A composed item may be transmitted over the wireless network 4205 through the communication subsystem 4204.

For voice communications, the overall operation of the mobile device 4200 is substantially similar, except that the received signals are output to the speaker 4218, and signals for transmission are generated by the microphone 4220. Alternative voice or audio I/O subsystems, such as a voice message recording subsystem, can also be implemented on the mobile device 4200. Although voice or audio signal output is accomplished primarily through the speaker 4218, the display 4210 can also be used to provide additional information such as the identity of a calling party, duration of a voice call, or other voice call related information.

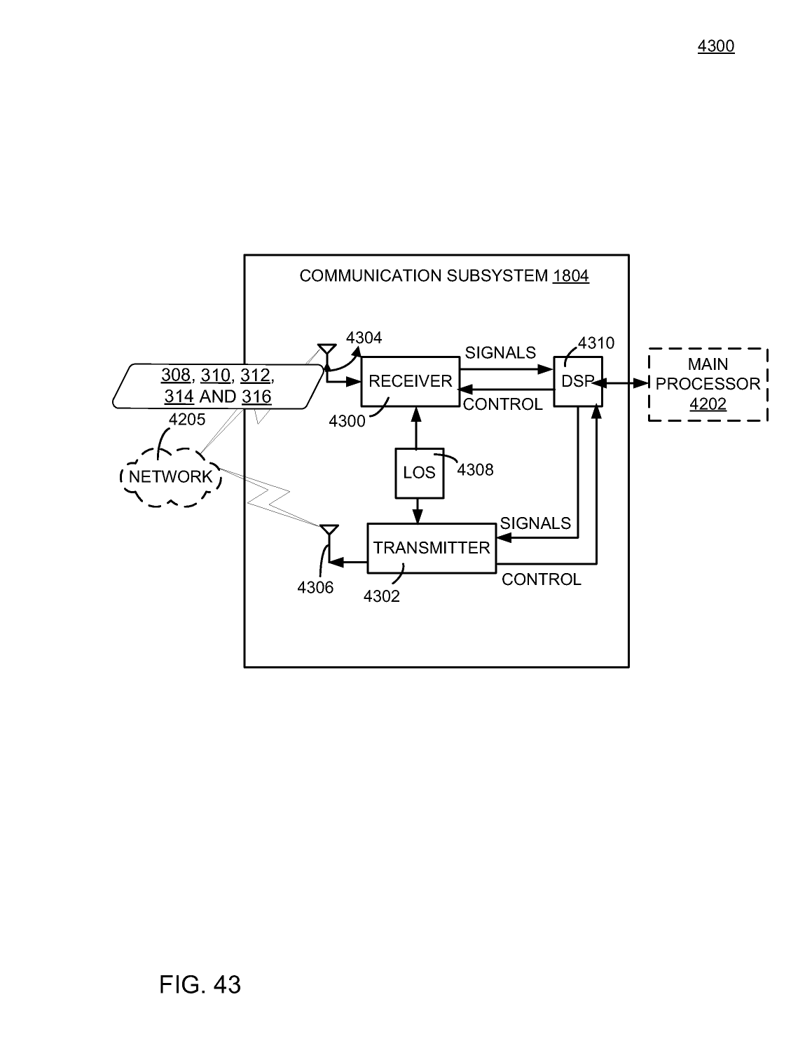

Referring now to FIG. 43, a block diagram of the communication subsystem component 4204 is shown, according to an implementation. The communication subsystem 4204 includes a receiver 4300, a transmitter 4302, as well as associated components such as one or more embedded or internal antenna elements 4304 and 4306, Local Oscillators (LOs) 4308, and a processing module such as a Digital Signal Processor (DSP) 4310. The particular implementation of the communication subsystem 4204 is dependent upon the communication wireless network 4205 with which the mobile device 4200 is intended to operate. Thus, it should be understood that the implementation illustrated in FIG. 43 serves only as one example.

Signals received by the antenna 4304 through the wireless network 4205 are input to the receiver 4300, which may perform such common receiver functions as signal amplification, frequency down conversion, filtering, channel selection, and analog-to-digital (A/D) conversion. A/D conversion of a received signal allows more complex communication functions such as demodulation and decoding to be performed in the DSP 4310. In a similar manner, signals to be transmitted are processed, including modulation and encoding, by the DSP 4310. These DSP-processed signals are input to the transmitter 4302 for digital-to-analog (D/A) conversion, frequency up conversion, filtering, amplification and transmission over the wireless network 4205 via the antenna 4306. The DSP 4310 not only processes communication signals, but also provides for receiver and transmitter control. For example, the gains applied to communication signals in the receiver 4300 and the transmitter 4302 may be adaptively controlled through automatic gain control algorithms implemented in the DSP 4310.

The wireless link between the mobile device 4200 and the wireless network 4205 can contain one or more different channels, typically different RF channels, and associated protocols used between the mobile device 4200 and the wireless network 4205. An RF channel is a limited resource that must be conserved, typically due to limits in overall bandwidth and limited battery power of the mobile device 4200.

When the mobile device 4200 is fully operational, the transmitter 4302 is typically keyed or turned on only when it is transmitting to the wireless network 4205 and is otherwise turned off to conserve resources. Similarly, the receiver 4300 is periodically turned off to conserve power until the receiver 4300 is needed to receive signals or information (if at all) during designated time periods.

The configuration data 108, the diagnostic results 112 and the calibration results 116 is received by the communication subsystem 4204 from the wireless network 4205 through the antenna 4304 of the receiver 4300 and transferred to the DSP 4310 and to the main processor 4202.

FIG. 44 is a block diagram of a thermometer control computer 4400, according to an implementation. The thermometer control computer 4400 includes a processor (such as a Pentium III processor from Intel Corp. in this example) which includes dynamic and static ram and non-volatile program read-only-memory (not shown), operating memory 4404 (SDRAM in this example), communication ports 4406 (e.g., RS-232 4408 COM1/2 or Ethernet 4410), and a data acquisition circuit 4412 with analog inputs 4414 and analog outputs 4416.

In some implementations of the thermometer control computer 4400, the data acquisition circuit 4412 is also coupled to counter timer ports 4440 and watchdog timer ports 4442. In some implementations of the thermometer control computer 4400, an RS-232 port 4444 is coupled through a universal asynchronous receiver/transmitter (UART) 4446 to a bridge 4426.

In some implementations of the thermometer control computer 4400, the Ethernet port 4410 is coupled to the bus 4428 through an Ethernet controller 4450.

With proper digital amplifiers and analog signal conditioners, the thermometer control computer 4400 can be programmed to drive the display device 3402. The sensed temperatures can be received by thermal sensors 110 and 3112, the output of which, after passing through appropriate signal conditioners, can be read by the analog to digital converters that are part of the data acquisition circuit 4412. Thus the temperatures can be made adjusted for ambient temperature or the physical site of the human or animal that was examined for temperature on in as part of its decision-making software that acts to process and display sensed temperature.

FIG. 45 is a block diagram of a data acquisition circuit 4500 of a thermometer control computer, according to an implementation. The data acquisition circuit 4500 is one example of the data acquisition circuit 4412 in FIG. 44 above. Some implementations of the data acquisition circuit 4500 provide 16-bit A/D performance with input voltage capability up to +/−10V, and programmable input ranges.

The data acquisition circuit 4500 can include a bus 4502, such as a conventional PC/104 bus. The data acquisition circuit 4500 can be operably coupled to a controller chip 4504. Some implementations of the controller chip 4504 include an analog/digital first-in/first-out (FIFO) buffer 4506 that is operably coupled to controller logic 4508. In some implementations of the data acquisition circuit 4500, the FIFO 4506 receives signal data from and analog/digital converter (ADC) 4510, which exchanges signal data with a programmable gain amplifier 4512, which receives data from a multiplexer 4514, which receives signal data from analog inputs 4516.

In some implementations of the data acquisition circuit 4500, the controller logic 4508 sends signal data to the ADC 4510 and a digital/analog converter (DAC) 4518. The DAC 4518 sends signal data to analog outputs. The analog outputs, after proper amplification, can be used to modulate coolant valve actuator positions. In some implementations of the data acquisition circuit 4500, the controller logic 4508 receives signal data from an external trigger 4522.

In some implementations of the data acquisition circuit 4500, the controller chip 4504 includes a digital input/output (I/O) component 4538 that sends digital signal data to computer output ports.

In some implementations of the data acquisition circuit 4500, the controller logic 4508 sends signal data to the bus 4502 via a control line 4546 and an interrupt line 4548. In some implementations of the data acquisition circuit 4500, the controller logic 4508 exchanges signal data to the bus 4502 via a transceiver 4550.

Some implementations of the data acquisition circuit 4500 include 12-bit D/A channels, programmable digital I/O lines, and programmable counter/timers. Analog circuitry can be placed away from the high-speed digital logic to ensure low-noise performance for important applications. Some implementations of the data acquisition circuit 4500 are fully supported by operating systems that can include, but are not limited to, DOS™, Linux™, RTLinux™, QNX™, Windows 98/NT/2000/XP/CE™, Forth™, and VxWorks™ to simplify application development.

### CONCLUSION

A hand-held medical device that performs diagnostics and calibration at the direction of a mobile device is described. A technical effect of the hand-held medical device is diagnostics and calibration of the hand-held medical device. Although specific implementations are illustrated and described herein, it will be appreciated by those of ordinary skill in the art that any arrangement which is calculated to achieve the same purpose may be substituted for the specific implementations shown. This application is intended to cover any adaptations or variations.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future non-contact temperature sensing devices, different cables and new mobile device.

The terminology used in this application meant to include all temperature sensors, processors and user environments and alternate technologies which provide the same functionality as described herein.

1. A method of a non-contact thermometer, the method comprising:
connecting to a mobile device via a cable;
recognizing the mobile device;
entering a calibration and diagnostic mode;
sending configuration data to the mobile device;
receiving generated diagnostic instructions for the non-contact thermometer from the mobile device;
performing the generated diagnostic instructions, yielding results of performed diagnostic instructions;
transmitting the results of the performed diagnostic instructions to the mobile device;
receiving generated calibration instructions for the non-contact thermometer from the mobile device;
performing the generated calibration instructions, yielding results of performed calibration instructions; and
transmitting the results of the performed calibration instructions to the mobile device.

2. The method of claim 1, wherein the cable further comprises:
a USB cable.

3. A method of a non-contact thermometer, the method comprising:
sending configuration data to a mobile device;
receiving diagnostic instructions for the non-contact thermometer from the mobile device;
transmitting results of the diagnostic instructions to the mobile device;
receiving calibration instructions for the non-contact thermometer from the mobile device; and
transmitting the results of the calibration instructions to the mobile device.

4. The method of claim 3, further comprising:
connecting to the mobile device via a cable.

5. The method of claim 4, wherein the cable further comprises:
a USB cable.

6. The method of claim 4, further comprising:
recognizing the mobile device.

7. The method of claim 6, further comprising:
entering a calibration and diagnostic mode.

8. The method of claim 3, further comprising:
performing the diagnostic instructions, yielding results of diagnostic instructions.

9. The method of claim 3, further comprising:
performing the calibration instructions, yielding results of performed calibration instructions.

10. A non-transitory computer-accessible medium having computer executable instructions to control a non-contact thermometer, the computer executable instructions capable of directing a processor to perform:
receiving calibration instructions for the non-contact thermometer from a mobile device; and
transmitting results of the calibration instructions to the mobile device.

11. The non-transitory computer-accessible medium of claim 10, wherein the computer executable instructions further comprise computer executable instructions capable of directing the processor to perform:
sending configuration data to the mobile device.

12. The non-transitory computer-accessible medium of claim 11, wherein the computer executable instructions further comprise computer executable instructions capable of directing the processor to perform:
receiving diagnostic instructions for the non-contact thermometer from the mobile device.

13. The non-transitory computer-accessible medium of claim 12 wherein the computer executable instructions further comprise computer executable instructions capable of directing the processor to perform:
performing the diagnostic instructions, yielding results of diagnostic instructions.

14. The non-transitory computer-accessible medium of claim 13, wherein the computer executable instructions further comprise computer executable instructions capable of directing the processor to perform:
transmitting results of the diagnostic instructions to the mobile device.

15. The non-transitory computer-accessible medium of claim 10, wherein the computer executable instructions further comprise computer executable instructions capable of directing the processor to perform:
connecting to the mobile device via a cable.

16. The non-transitory computer-accessible medium of claim 15, wherein the computer executable instructions further comprise computer executable instructions capable of directing the processor to perform:
recognizing the mobile device.

17. The non-transitory computer-accessible medium of claim 16, wherein the computer executable instructions further comprise computer executable instructions capable of directing the processor to perform:
entering a calibration and diagnostic mode.

18. The non-transitory computer-accessible medium of claim 10, wherein the computer executable instructions further comprise computer executable instructions capable of directing the processor to perform:
performing the calibration instructions, yielding results of performed calibration instructions.
